(19) United States
(12) Patent Application Publication
(10) Pub. No.: US 2004/0154931 A1
(43) Pub. Date: Aug. 12, 2004

(54) Polishing liquid, polishing method and polishing apparatus

(76) Inventors: Akihisa Hongo, Yokohama-shi (JP); Ryoichi Kimizuka, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/364,404

(22) Filed: Feb. 12, 2003

(51) Int. Cl. B23H 3/08

(52) U.S. Cl. 205/676

(57) ABSTRACT

The present invention relates to a polishing liquid for polishing the surface of a substrate having a copper film and fine recesses filled with the copper, comprising, at least one water-soluble inorganic acid or its salt, or water-soluble organic acid or its salt, and at least one hydroxyquinoline.

### BACKGROUND OF THE INVENTION

1. Field of the Invention

The present invention relates to a polishing liquid, a polishing method and a polishing apparatus, and more particularly to a polishing liquid for use in removing (polishing) an extra copper, etc. deposited on a substrate, upon forming embedded interconnects by embedding a conductor, such as copper, in interconnect trenches formed in an interlevel dielectric in the formation of a semiconductor device of a multi-layer structure, and to a polishing method and a polishing apparatus using the polishing liquid.

2. Description of the Related Art

In recent years, instead of using aluminum or aluminum alloys as a material for forming interconnection circuits on a substrate such as a semiconductor wafer, there is an eminent movement towards using copper (Cu) which has a low electric resistivity and high electromigration resistance. Copper interconnects are generally formed by filling copper into fine recesses formed in the surface of a substrate, followed by removal of unnecessary copper by chemical mechanical polishing (CMP) the so-called “damascene process”. There are known various techniques for forming such copper interconnects, including CVD, sputtering, and plating. According to any such technique, a copper film is formed in the substantially entire surface of a substrate.

FIGS. 18A through 18C illustrate, in sequence of process steps, an example of forming such a substrate W having copper interconnects. As shown in FIG. 18A, an insulating film 2, such as an oxide film of SiO₂ or an other film of low-k material, is deposited on a conductive layer 1a in which semiconductor devices are formed, which is formed on a semiconductor base 1. Contact holes 3 and trenches 4 for interconnects are formed in the insulating film 2 by the lithography/etching technique. Thereafter, a barrier layer 5 of TaN or the like is formed on the entire surface, and a seed layer 7 as an electric supply layer for electroplating is formed on the barrier layer 5. As the barrier layer 5, Ta/TaN mixed layer or TiN, WN, SiTiN, CoWP or COWB film may be employed.

Then, as shown in FIG. 18B, copper plating is performed onto the surface of the substrate W to fill the contact holes 3 and the trenches 4 with copper and, at the same time, deposit a copper film 6 on the insulating film 2. Thereafter, the copper film 6 and the barrier layer 5 on the insulating film 2 are removed by chemical mechanical polishing (CMP) so as to make the surface of the copper film 6 filled in the contact holes 3 and the trenches 4 for interconnects and the surface of the insulating film 2 lie substantially on the same plane. Interconnects composed of the copper film 6 as shown in FIG. 18C is thus formed.

The damascene process, however, is not a complete technique yet, and has many problems to be solved. Thus, as described above, in order to embed copper metal securely in the interconnect trenches 4, etc., after formation of the interconnect trenches 4 in the insulating layer 2 and deposition of the barrier layer 5 and seed layer 7 on the substrate surface, it is necessary to deposit copper film 6 in excess on the insulating layer 2. The excess deposition inevitably leads to formation of irregularities in the surface of copper film 6. In polishing and flattening of such an extra copper film 6, there are involved the following problems to be solved:

\mathring{1} The use of a high polishing pressure for increasing the polishing rate tends to cause scratches, dishing, erosion, recesses, etc. in the polished copper surface, thereby lowering the product quality. The polishing rate can therefore be increased with difficulty, and the productivity must be sacrificed.

\mathring{2} A low-k material having a low hardness is expected to be widely employed in the future as a material for an insulating layer. The use of a low-k material, however, makes the above problem more serious.

\mathring{3} In CMP processing, a polishing slurry liquid (polishing liquid) costs a great deal. Recovery and reuse of the polishing slurry liquid used is therefore desired. With the current technology, however, it is not easy to practically carry out the recovery/reuse process.

\mathring{4} A considerable amount of polishing slurry is thus currently discharged from the production line. This is undesirable also in the light of environmental conservation.

### SUMAMRY OF THE INVENTION

The present invention has been made of in view of the above problems in the related art. It is therefore an object of the present invention to provide a polishing liquid useful for polishing an extra copper film deposited on a substrate more efficiently at a low cost while preventing a lowering of the product quality, and a polishing method and a polishing apparatus using the polishing liquid.

In order to achieve the above object, the present invention provides a polishing liquid for polishing the surface of a substrate having a copper film and fine recesses filled with the copper, comprising; at least one water-soluble inorganic acid or its salt, or water-soluble organic acid or its salt, and at least one hydroxyquinoline.

When a copper film is electrolyzed utilizing the copper film as an anode in the polishing liquid containing at least one hydroxyquinoline, the copper gradually dissolves and reacts with the hydroxyquinoline to form an insoluble oxine-copper film in the surface of the copper film even when an oxidizing agent, whose concentration control is difficult because of its spontaneous decomposition, is not used. The equation of the reaction between copper and 8-hydroxyquinoline is as follows:

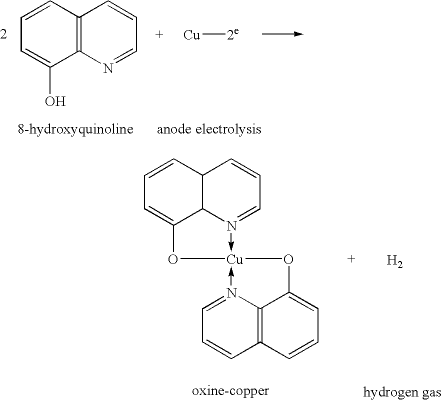

The insoluble oxine-copper is quite fragile mechanically and can be easily polished away by polishing with a polishing tool, such as a polishing pad. Further, the oxine-copper has a relatively high electric resistance. Accordingly, flowing of electric current through the portions covered with oxine-copper is inhibited.

The inorganic acid or its salt may be a potassium or ammonium salt of an inorganic acid, and the organic acid or its salt may be a potassium, ammonium, amine or hydroxyamine salt of an organic acid.

Specific examples of the inorganic acid may include phosphoric acid, pyrophosphoric acid, sulfuric acid, nitric acid, hydrochloric acid, sulfamic acid, and hydrofluoric acid. Specific examples of the organic acid may include formic acid, acetic acid, propionic acid, oxalic acid, malonic acid, maleic acid, succinic acid, citric acid, gluconic acid, butyric acid, glycine, aminobenzoic acid, nicotinic acid and methanesulfonic acid. These acids may be used either singly or as a mixture of two or more, e.g. hydrofluoric acid and nitric acid.

The hydroxyquinoline may be 2-hydroxyquinoline, 4-hydroxyquinoline, 5-hydroxyquinoline or 8-hydroxyquinoline. 8-hydroxyquinoline, which is currently used as an industrial chemical and is readily available at a relatively low cost, is most preferred for its properties and cost.

The concentration of the water-soluble inorganic acid or its salt, or the water-soluble organic acid or its salt in the polishing liquid may be 0.01 to 5.0 mol/L. The electric conductivity of the polishing liquid may be 0.5 to 100 mS/cm, and preferably 5 mS/cm or higher when using an electrolytic current of 1 A/dm² or higher.

The concentration of the hydroxyquinoline in the polishing liquid may be 0.001 to 1.0% by weight, preferably 0.01 to 0.2% by weight, more preferably 0.05 to 0.2% by weight.

It is possible to add to the polishing liquid one or more of benzotriazole or its derivative, benzoimidazole and phenacetin as an antidiscoloration and anticorrosion agent for copper in a concentration of 0.001 to 0.5% by weight. In this connection, when benzotriazole is added in an amount of 100 mg/L or more to a polishing liquid of a pH of 8 or higher, a stable complex film can be formed excessively in the surface of copper whereby the formation of oxine-copper may be prevented. The type and concentration of a chemical to be used should therefore be properly selected depending upon the conditions of the polishing liquid.

The pH of the polishing liquid may be in the range of 3-11. The insoluble oxine-copper film grows relatively easily in the pH range of 5-9, and the oxine-copper film can grow even into the maximum thickness of 1 mm. The pH of polishing liquid may be selected depending upon the purpose and progress of polishing. Thus, though the polishing liquid is basically used in the neutral pH range, in which an oxine-copper film most easily forms, throughout the polishing process, the pH of the polishing liquid may be lowered, e.g. in an early stage of polishing when the whole surface of an insulating layer is covered with copper, so as to quickly remove copper with a high current density mainly by electropolishing. In this case, it is preferred to increase the concentration of phosphoric acid, and add an alkylene glycol or alkylene glycol alkyl ether to the polishing liquid in order to enhance the flattening effect. The pH of the polishing liquid may be lowered, or raised in the final stage of polishing in order to enhance polishing selectivity with respect to a barrier layer.

A surfactant may be added to the polishing liquid in a concentration of 0.001 to 0.1% by weight. The addition of a nonionic surfactant, e.g. polyoxyalkylene alkyl ether, can suppress excessive polishing of an insulating layer or copper and increase the polishing rate of a remaining barrier layer. When taking polishing selectivity, dispersibility of abrasive grains, washability with water, influences on a later process step, etc. totally into consideration, it is appropriate to use a nonionic surfactant, such as a polyoxyethylene glycol alkyl ether, a polyoxyethylene/polyoxypropylene condensate, an acetylene glycol, or an ethylenediamine polyoxyalkylene glycol.

The present invention provides an electrochemical/chemical/mechanical composite polishing method for polishing the surface of a substrate having a copper film and fine recesses filled with the copper, comprising: electropolishing the surface of the substrate in a polishing liquid containing at least one water-soluble inorganic acid or its salt, or water-soluble organic acid or its salt, and at least one hydroxyquinoline; and simultaneously polishing away an oxine-copper film formed in the copper surface by the reaction between copper and the hydroxyquinoline added in the polishing liquid.

According to the polishing method, polishing of the substrate can be effected by repeatedly polishing away the insoluble oxine-copper film formed in the copper surface by the reaction between copper and the hydroxyquinoline. The oxine-copper film has a relatively high electric resistance. Flowing of electric current through the portions covered with the oxine-copper film is therefore inhibited, and the electric current is likely to concentrate on the metal-exposed portions. Further, the oxine-copper film is quite fragile mechanically and can be easily polished away with a rotating low-pressure polishing tool, such as a polishing pad. Accordingly, in polishing an extra copper film with irregularities deposited on an insulating layer, for example in a damascene process for the manufacturing of a semiconductor device, by electrolyzing the copper surface as an anode in the polishing liquid containing a hydroxyquinoline and, at the same time, polishing the surface with a polishing tool such as a polishing pad, the oxine-copper film formed in the copper surface is selectively polished away with respect to the raised portions and the electric current concentrates on the exposed copper surface to thereby form an oxine-copper film again. By continuing the operation while supplying an effective electric current, the copper film can be effectively polished into flatness at a higher rate as compared to the conventional technique.

The electropolishing may be carried out by supplying either a direct current or a pulse current, or a superimposed current thereof.

The electropolishing may be carried out by initially supplying such an electric current that creates a current density, per surface area of copper, of 0.5 to 5.0 A/dm².

In a preferred embodiment, a number of anodes and cathodes, facing the copper film of the substrate, are disposed alternately in the polishing liquid such that the cathodes are closer to the substrate than the anodes, and a voltage is applied between the anodes and the cathodes to make the copper surface positive polar due to a bipolar phenomenon, thereby forming an oxine-copper film in the copper surface.

According to this embodiment, by utilizing the bipolar phenomenon, the oxine-copper film can be formed in the copper surface even when removal of an extra copper film deposited on the substrate has advanced and the underlying layer, such as a barrier layer, becomes exposed whereby uniform supplying of electric current from an outer terminal, such as an electrical contact, to the copper film becomes impossible.

The resistance between the cathodes and the anodes in the polishing liquid may be 10 to 50 Ωcm, and the voltage applied between the cathodes and the anodes may be 10 to 100 V.

The present invention provides a polishing apparatus for polishing the surface of a substrate having a copper film and fine recesses filled with the copper, characterized by electropolishing the surface of the substrate in a polishing liquid containing at least one water-soluble inorganic acid or its salt, or water-soluble organic acid or its salt, and at least one hydroxyquinoline, and simultaneously polishing away an oxine-copper film formed in the copper surface by the reaction between copper and the hydroxyquinoline.

The present invention also provides a polishing apparatus, comprising: a substrate holder for holding a substrate with its surface facing downward; a polishing bath holding a polishing liquid containing at least one water-soluble inorganic acid or its salt, or water-soluble organic acid or its salt, and at least one hydroxyquinoline; a cathode plate immersed in the polishing liquid held in the polishing bath; a polishing tool disposed opposite to the cathode plate and immersed in the polishing liquid held in the polishing bath; and a relative movement mechanism for allowing the substrate held by the substrate holder and the polishing tool to make a relative movement.

A number of grooves, extending continuously over the full length of the cathode plate, may be formed in the surface of the cathode plate. This makes it possible to supply the polishing liquid by passing the polishing liquid through the grooves, and discharge products, hydrogen gas, oxygen gas, etc. through the grooves.

The present invention provides a polishing apparatus, comprising: a substrate holder for holding a substrate; a polishing bath holding a polishing liquid containing at least one water-soluble inorganic acid or its salt, or water-soluble organic acid or its salt, and at least one hydroxyquinoline; an electrode plate having a number of anodes and cathodes electrically isolated from one another and disposed alternately such that the cathodes are closer to the substrate held by the substrate holder than the anodes; a power source for applying a voltage between the anodes and the cathodes; a polishing tool disposed opposite to the electrode plate and immersed in the polishing liquid held in the polishing bath; and a relative movement mechanism for allowing the substrate held by the substrate holder and the polishing tool to make a relative movement.

A number of grooves, extending continuously over the full length of the cathode plate, may be formed in the surface of the cathode plate.

The present invention provides a polishing apparatus, comprising: a first polishing apparatus; including, (i) a substrate holder for holding a substrate with its surface downward, (ii) a polishing bath holding a polishing liquid containing at least one water-soluble inorganic acid or its salt, or water-soluble organic acid or its salt, and at least one hydroxyquinoline, (iii) a cathode plate immersed in the polishing liquid held in the polishing bath, (iv) a polishing tool disposed opposite to the cathode plate and immersed in the polishing liquid held in the polishing bath, and (v) a relative movement mechanism for allowing the substrate held by the substrate holder and the polishing tool to make a relative movement; and a second polishing apparatus; including (i) a substrate holder for holding a substrate, (ii) a polishing bath holding a polishing liquid containing at least one water-soluble inorganic acid or its salt, or water-soluble organic acid or its salt, and at least one hydroxyquinoline, (iii) an electrode plate having a number of anodes and cathodes electrically isolated from one another and disposed alternately such that the cathodes are closer to the substrate held by the substrate holder than the anodes, (iv) a power source for applying a voltage between the anodes and the cathodes, (v) a polishing tool disposed opposite to the electrode plate and immersed in the polishing liquid held in the polishing bath, and (vi) a relative movement mechanism for allowing the substrate held by the substrate holder and the polishing tool to make a relative movement; wherein the first polishing apparatus and the second polishing apparatus are disposed in the same partitioned room or module, and the substrate is moved between the polishing apparatuses by a pivotable arm.

### BRIEF DESCRIPTION OF THE DRAWINGS

FIG. 1 is a graph showing the relationship between weight loss of copper and copper-immersion time in the polishing liquid of the present invention;

FIG. 2 is a graph showing the relationship between anode-cathode voltage and electrolysis time in the polishing liquid of the present invention;

FIG. 3 is a graph showing the relationship between electropolishing current and electrolysis time, and between weight loss of copper and electrolysis time in the polishing liquid of the present invention;

FIG. 4 is a cross-sectional view schematically showing a polishing apparatus according to an embodiment of the present invention;

FIGS. 5A through 5C are diagrams illustrating a pattern of the progress of polishing carried out by the polishing apparatus shown in FIG. 4;

FIG. 6 is a cross-sectional view schematically showing a polishing apparatus according to another embodiment of the present invention;

FIGS. 7A through 7C are diagrams illustrating a pattern of the progress of polishing carried out by the polishing apparatus shown in FIG. 6;

FIG. 8 is a layout plan of an interconnects-forming apparatus provided with the polishing apparatuses shown in FIGS. 4 and 6;

FIG. 9 is a block diagram showing the flow of process steps in the interconnects-forming apparatus shown in FIG. 8;

FIGS. 10A through 10C are cross-sectional views illustrating, in sequence of process steps, an example of the formation of interconnects in the interconnects-forming apparatus shown in FIG. 8;

FIG. 11 is a plan view of a polishing apparatus according to still another embodiment of the present invention;

FIGS. 12A and 12B are front views showing a substrate holder for use in the polishing apparatus shown in FIG. 11;

FIG. 13 is a layout plan of an interconnects-forming apparatus provided with the polishing apparatus shown in FIG. 11;

FIG. 14 is a cross-sectional view schematically showing a polishing apparatus according to still another embodiment of the present invention;

FIG. 15 is an enlarged plan view of a portion of the electrode plate of the polishing apparatus shown in FIG. 14;

FIG. 16 is an enlarged sectional view of a portion of the electrode plate of the polishing apparatus shown in FIG. 14;

FIG. 17 is a cross-sectional view of the sample used in the working examples;

FIG. 18A through 18C are cross-sectional views illustrating, in sequence of process steps, an example of the formation of copper interconnects;

FIG. 19 is a cross-sectional view showing a whole structure of an electroplating apparatus as a copper plating apparatus, at the time of plating process;

FIG. 20 is a diagram showing a flow of a plating solution in the electroplating apparatus as the copper plating apparatus, at a time of plating process;

FIG. 21 is a cross-sectional view showing a whole structure of the electroplating apparatus as the copper plating apparatus, at the time of non-plating process (at the time of transfer of a substrate);

FIG. 22 is a cross-sectional view showing a whole structure of the electroplating apparatus as the copper plating apparatus, at the time of maintenance;

FIG. 23 is a cross-sectional view explanatory of a relationship among a housing, a pressing ring, and a substrate of the electroplating apparatus as the copper plating apparatus, at the time of transfer of a substrate;

FIG. 24 is an enlarged view showing a part of FIG. 23;

FIGS. 25A through 25D are schematic views explanatory of the flow of a plating solution of the electroplating apparatus as the copper plating apparatus, at the time of plating process and at the time of non-plating process;

FIG. 26 is an enlarged cross-sectional view showing a centering mechanism of the electroplating apparatus as the copper plating apparatus;

FIG. 27 is a cross-sectional view showing a feeding contact (probe) of the electroplating apparatus as the copper plating apparatus;

FIG. 28 is a plan view showing another example of an electroplating apparatus as a copper plating apparatus;

FIG. 29 is a cross-sectional view taken along the line A-A of FIG. 28;

FIG. 30 is a cross-sectional view of a substrate holding portion and a cathode portion of the electroplating apparatus as the copper plating apparatus;

FIG. 31 is a cross-sectional view of an electrode arm portion of the electroplating apparatus as the copper plating apparatus;

FIG. 32 is a plan view showing the electrode arm portion, from which a housing is removed, of the electroplating apparatus as the copper plating apparatus;

FIG. 33 is a schematic view showing an anode and a plating solution impregnated material of the electroplating apparatus as the copper plating apparatus;

FIG. 34 is a layout plan showing a substrate processing apparatus;

FIG. 35 is a view showing airflow in the substrate processing apparatus shown in FIG. 34;

FIG. 36 is a view showing airflows among areas in the substrate processing apparatus shown in FIG. 34;

FIG. 37 is a perspective view of the substrate processing apparatus shown in FIG. 34, which is placed in a clean room;

FIG. 38 is a layout plan showing another example of a substrate processing apparatus;

FIG. 39 is a layout plan showing still another example of a substrate processing apparatus;

FIG. 40 is a layout plan showing still another example of a substrate processing apparatus;

FIG. 41 is a layout plan showing still another example of the substrate processing apparatus;

FIG. 42 is a layout plan showing still another example of the substrate processing apparatus;

FIG. 43 is a layout plan showing still another example of the substrate processing apparatus;

FIG. 44 is a layout plan showing still another example of the substrate processing apparatus;

FIG. 45 is a layout plan showing still another example of the substrate processing apparatus;

FIG. 46 is a layout plan showing still another example of the substrate processing apparatus;

FIG. 47 is a flow chart showing a flow of the respective steps in the substrate processing apparatus shown in FIG. 46;

FIG. 48 is a schematic view showing a bevel and backside cleaning unit;

FIG. 49 is a schematic view showing an example of an electroless plating apparatus;

FIG. 50 is a schematic view showing another example of an electroless plating apparatus;

FIG. 51 is a vertical sectional view showing an example of an annealing unit; and

FIG. 52 is a transverse sectional view of the annealing unit of FIG. 51.

### DETAILED DESCRIPTION OF THE PREFERRED EMBODIMENTS

Preferred embodiments of the present invention will now be described with reference to the drawings.

The polishing liquid of the present invention comprises at least one water-soluble inorganic acid or its salt, or water-soluble organic acid or its salt, and at least one hydroxyquinoline. The composition and properties of the polishing liquid, the action and effect of the hydroxyquinoline in the polishing liquid, and the construction of a polishing apparatus for use in polishing using the polishing liquid will now be described in order. Further, experimental examples of polishing carried out by using the polishing liquid will be described.

[Composition and Properties of Polishing Liquid]

Specific examples of the water-soluble inorganic acid or its salt contained in the polishing liquid of the present invention may include inorganic acids such as phosphoric acid, pyrophosphoric acid, sulfuric acid, nitric acid, hydrochloric acid, sulfamic acid, and hydrofluoric acid; and potassium or ammonium salts of these inorganic acids. Specific examples of the water-soluble organic acid or its salt may include organic acids such as formic acid, acetic acid, propionic acid, oxalic acid, malonic acid, maleic acid, succinic acid, citric acid, gluconic acid, butyric acid, glycine, aminobenzoic acid, nicotinic acid and methanesulfonic acid; and potassium, ammonium, alkylamine or hydroxyalkylamine salts of these organic acids. Such acids or salts may be used either singly or as a mixture of two or more. The concentration (total concentration) of the water-soluble inorganic acid or its salt, or the water-soluble organic acid or its salt may be e.g. 0.01 to 5.0 mol/L. The electric conductivity of the polishing liquid may be e.g. 0.5 to 100 mS/cm, and preferably 5 mS/cm or higher when using an electrolytic current of 1 A/dm² or higher.

One or more of 2-hydroxyquinoline, 4-hydroxyquinoline, 5-hydroxyquinoline and 8-hydroxyquinoline, for example, may be used as the hydroxyquinoline. Of these, 8-hydroxyquinoline is most preferred for its properties and cost. The concentration of such a hydroxyquinoline may be e.g. 0.001 to 1.0% by weight, preferably 0.05 to 0.2% by weight. 8-hydroxyquinoline is currently used as an industrial chemical, and is readily available at a relatively low cost.

When electropolishing of copper is carried out, utilizing the copper as an anode, in the polishing liquid containing the water-soluble inorganic acid or its salt, or the water-soluble organic acid or its salt, and 8-hydroxyquinoline, the copper is dissolved and, at the same, reacts with 8-hydroxyquinoline following the above-described equation to form insoluble oxine-copper in the surface of copper. The oxine-copper grows into a scale-like film as the electrolysis is continued. The oxine-copper film has a high electric resistance, and therefore incurs a rise of voltage. As the electrolysis is further continued, the film falls off from the copper surface, and then a new oxine-copper is formed and grows into a film. Such growth and falling-off of the oxine-copper film are repeated.

The polishing liquid may be used in a broad pH range of e.g. 3-11. In electropolishing of copper in the polishing liquid, utilizing the copper as an anode, the insoluble oxine-copper film grows relatively easily on the surface of copper in the pH range of 5-9, and the oxine-copper film can grow even into the maximum thickness of 1 mm. The pH of polishing liquid may be selected depending upon the purpose and progress of polishing. Thus, though the polishing liquid is basically used in the neutral pH range, in which an oxine-copper film most easily forms, throughout the polishing process, the pH of the polishing liquid maybe lowered, e.g. in an early stage of polishing when the whole surface of an insulating layer is covered with copper, so as to quickly remove copper with a high current density mainly by electropolishing. In this case, it is preferred to increase the concentration of phosphoric acid, and add an alkylene glycol or alkylene glycol alkyl ether to the polishing liquid in order to enhance the flattening effect. The pH of the polishing liquid may be lowered, or raised in the final stage of polishing in order to enhance polishing selectivity with respect to a barrier layer.

It is possible to add to the polishing liquid benzotriazole or its derivative, benzoimidazole or phenacetin, or the like as an antidiscoloration and anticorrosion agent for copper in an amount of e.g. 10 to 1000 mg/L, thereby effectively preventing discoloration and corrosion of copper. It is to be noted, however, that when benzotriazole is added in an amount of 100 mg/L or more to a polishing liquid of a pH of 8 or higher, a stable complex film can be formed excessively in the surface of copper whereby the formation of oxine-copper may be prevented. The type and concentration of a chemical to be used should therefore be properly selected depending upon the conditions of the polishing liquid.

A surfactant may be added to the polishing liquid to suppress excessive polishing of an insulating layer or copper interconnects filled into interconnect trenches, and increase the polishing rate of a remaining barrier layer, thereby making the copper film fit for the final stage of polishing. When taking polishing selectivity, dispersibility of abrasive grains, washability with water, influences on a later process step, etc. totally into consideration, it is appropriate to use a nonionic surfactant, such as a polyoxyethylene glycol alkyl ether, a polyoxyethylene/polyoxypropylene condensate, an acetylene glycol, or an ethylenediamine polyoxyalkylene glycol.

As abrasive grains to be contained in the polishing liquid, it is preferable to use alumina, colloidal silica or a mixture of alumina and colloidal silica in an early stage of polishing which is directed to polishing of copper, whereas it is preferable to use colloidal silica in a later stage of polishing which includes polishing of a barrier layer.

In the case where the film thickness of an excessive copper film deposited on an insulating layer is as large as e.g. over 1000 nm, polishing may be carried out effectively by using a polishing liquid which does not contain abrasive grains, but contains phosphoric acid, an alkylene glycol, etc. and which has a large polarization effect at the surface of copper upon electrolysis, and using an electric current of not less than 3 A/dm², thereby polishing most of the excessive copper film at a high rate. Such a polishing liquid is less susceptible to a change in quality due to mixing-in of polished copper, making it possible to streamline a process of recovering a polishing liquid waste from a polishing apparatus, filtering the liquid and then carrying out concentration adjustment to reuse the polishing liquid.

[Action and Effect of Hydroxyquinoline in Polishing Liquid]

A polishing liquid was prepared by adding to and dissolving in pure water 10 g/L of ammonium oxalate, 10 g/L of glycine and 30 g/L of phosphoric acid as conductive components, adding ammonia water to adjust the pH of the solution to 8.5, and then adding to and dissolving in the solution 2 g/L of 8-hydroxyquinoline. When a copper foil test piece obtained by glossy copper sulfate plating was immersed in the polishing liquid kept at a temperature of 25° C., a pale yellow-green oxine-copper was formed in the surface of the copper foil. A plurality of preweighed copper foil test pieces were immersed in the polishing liquid, and were pulled up one by one at regular time intervals. The oxine-copper film in the surface of copper foil was wiped off, and the copper foil was water-washed, dried and weighed to determine the weight loss of the copper foil. The results are shown in FIG. 1. As can be seen from FIG. 1, copper dissolves gradually in the polishing liquid and forms oxine-copper, and several minutes after when the copper surface becomes covered with an oxine-copper film, dissolution of copper almost stops.

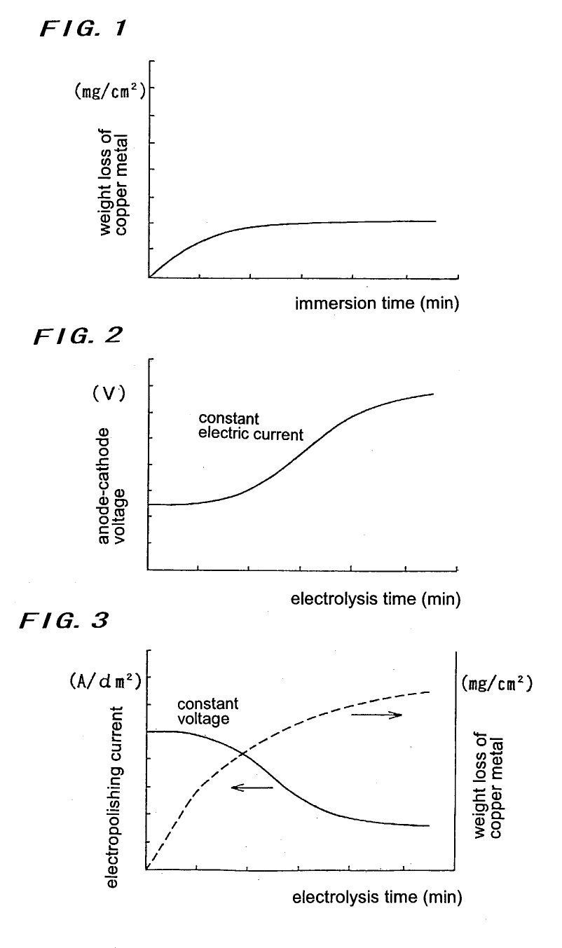

A pair of copper foils, disposed opposite to each other and serving as an anode and a cathode, were immersed in the same polishing liquid as described above, and a voltage was applied from a direct-current power source (rectifier) to between the electrodes to flow a constant electric current of 3 A/dm². The voltage applied between the electrodes during the electrolysis was measured, the results of which are shown in FIG. 2. As can be seen from FIG. 2, the electric current is flowed at a low voltage initially; the resistance becomes larger with the formation of oxine-copper film in the copper surface, and several minutes after, the voltage becomes almost twice the initial voltage.

The same electrolytic experiment as above was carried out, but keeping the voltage applied between the electrodes constant at 5.0 V. The change of electric current and the weight loss of copper foil with time during the electrolysis were measured, the results of which are shown in FIG. 3. As can be seen from FIG. 3, electric current of 4 A/dm² flowed initially; the current value decreased with time, and several minutes after becomes lower than half of the initial value; and the weight loss of copper foil almost corresponds to the amount of electricity applied.

It was confirmed that the oxine-copper film formed in the surface of the copper foil in the electrolysis is mechanically fragile, and can be easily wiped off especially in the wet state in the polishing liquid. Accordingly, when the film is polished away using a polishing tool such as a polishing pad, an adequate copper (oxine-copper film) polishing rate can be secured even with a polishing tool pressure as low as 100 to 300 g/cm².

As will be appreciated from the above-described nature of an oxine-copper film formed by the reaction between a hydroxyquinoline and copper, when polishing and flattening an excess copper film on an insulating layer in a damascene process for the manufacturing of a semiconductor device, by electropolishing the copper surface as an anode in the polishing liquid containing a hydroxyquinoline while polishing the copper surface with a rotating polishing tool, such as a polishing pad, the oxine-copper film formed in the surface of the copper film by electrolysis is polished away selectively with respect to raised portions, while depressed portions are protected. By continuing the operation by supplying an effective electric current, polishing and flattening of the copper film can be carried out efficiently and a product with little damage to the copper-interconnect layer can be produced.

[Construction of Polishing Apparatus for Use in Polishing with the Polishing Liquid]

A description will now be made of a polishing apparatus for use in polishing using the above-described polishing liquid.

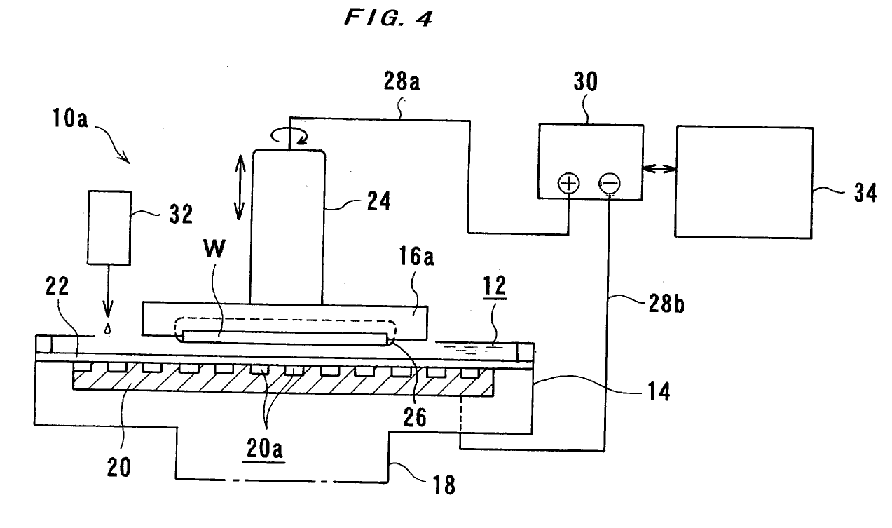

FIG. 4 shows a polishing apparatus 10a according to a first embodiment of the present invention. The polishing apparatus 10a includes an upwardly-open bottomed cylindrical polishing bath 14 for holding a polishing liquid 12 therein, and a substrate holder 16a, provided above the polishing bath 14, for detachably holding a substrate W with its front surface facing downward.

The polishing bath 14 is directly coupled to a main shaft 18 that rotates by the actuation of a motor, etc., and is provided at the bottom with a horizontally-disposed tabular cathode plate 20 which is made of a metal that is stable to the polishing liquid and is not passivated by electrolysis, such as SUS, Pt/Ti, Ir/Ti, Ti, Ta or Nb, and which is to be immersed in the polishing liquid 12 and become a cathode. In the upper surface of the cathode plate 20, there are provided a lattice-form of long grooves 20a extending linearly and crosswise over the full length of the cathode plate 20. Further, a polishing tool 22, for example, a continuous-foam, hard polishing pad of a nonwoven fabric type (e.g. SUBA800 manufactured by Rodel Nitta Company) is stuck on the upper surface of the cathode plate 20.

By rotation of the main shaft 18, the polishing bath 14 rotates integrally with the polishing tool 22. As the polishing liquid 12 is supplied, the polishing liquid 12 flows through the long grooves 20a, and products produced during electropolishing, hydrogen gas, oxygen gas, etc. also pass through the long grooves 20a and discharged out from between the substrate W and the polishing tool 22.

Though the polishing bath 14 is allowed to rotate according to this embodiment, it is also possible to allow the polishing bath 14 to make a scroll movement (translational rotation movement) or a reciprocating movement. The long grooves 20a are preferably arranged in a lattice form in the case where the polishing bath 14 makes a scroll movement, in order to prevent a current density difference between the central portion and the peripheral portion of the cathode plate 20 and allow the polishing liquid, hydrogen gas, etc. to flow smoothly along the long grooves 20a. In the case where the polishing bath 14 makes a reciprocating movement, the grooves 20a are preferably arranged in parallel in the movement direction.

The substrate holder 16a is coupled to the lower end of a support rod 24 which is provided with a rotating mechanism that can control rotational speed and a vertical-movement mechanism that can adjust polishing pressure. The substrate holder 16a is adapted to attract and hold the substrate W in a vacuum-attraction manner on the lower surface thereof.

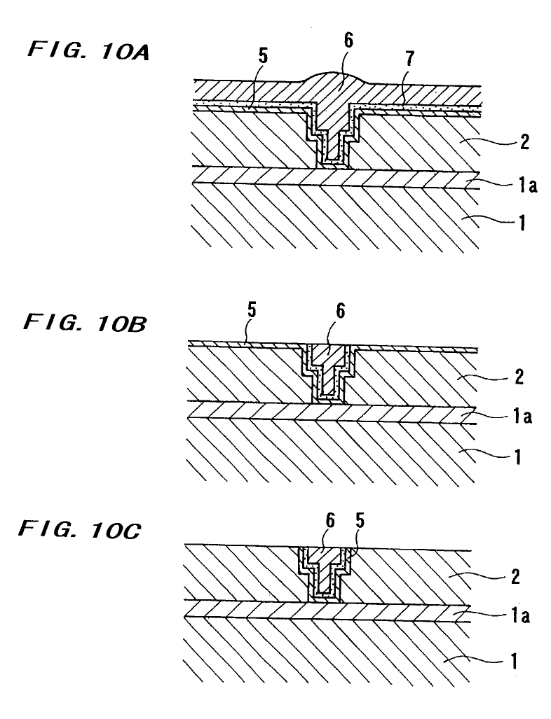

At a peripheral portion of the lower surface of the substrate holder 16a, there is provided electrical contacts 26 which, when the substrate W is attracted and held by the substrate holder 16a, contact a peripheral or bevel portion of the substrate W to make a copper film 6 (see FIG. 10A) deposited on the surface of the substrate W an anode. The electrical contacts 26 are connected, via a roll sliding connector built in the support rod 24 and a wire 28a, to the anode terminal of an externally-disposed rectifier 30 as a direct-current and pulse-current power source, and the cathode plate 20 is connected via a wire 28b to the cathode terminal of the rectifier 30.

The rectifier 30 is e.g. of low-voltage specification, and one with a capacity of about 15 V×20 A may be used for an 8-inch wafer and one with a capacity of 15 V×30 A may be used for a 12-inch wafer. The frequency of pulse current may range from normal frequency to microsecond.

Further, positioned above the polishing bath 14, a polishing liquid supply unit 32 for supplying the polishing liquid 12 into the polishing bath is provided. The polishing apparatus 10a is also provided with a control unit 34 for adjusting and managing the devices and the overall operation, and with a safety device (not shown).

The polishing apparatus 10a is suited for polishing the extra copper film 6 deposited on the surface of the substrate W while the copper film 6 remains uniformly as a continuous film as shown in FIG. 10A. The polishing operation will now be described.

The polishing liquid 12 is supplied into the polishing bath 14 and the polishing liquid 12 is allowed to overflow the polishing bath 14, while the polishing bath 14 is rotated integrally with the polishing tool 22 at a rotational speed of e.g. about 90 rpm. On the other hand, the substrate W, which has undergone plating such as copper plating, is attracted and held with its front surface facing downward by the substrate holder 16a. While rotating the substrate W in the opposite direction to the polishing bath 14 at a rotational speed of e.g. about 90 rpm, the substrate W is lowered so as to bring the surface (lower surface) of the substrate W into pressure contact with the surface of the polishing tool 22 at a constant pressure of e.g. about 300 g/cm² and, at the same time, a direct current, or a pulse current e.g. of a repetition of 10×10⁻³ second current-on and 10×10⁻³ second current-off, and creating a current density, per surface area of copper on the substrate, of e.g. about 1-4 A/dm², is supplied between the cathode plate 20 and the electrical contacts 26 by the rectifier 30.

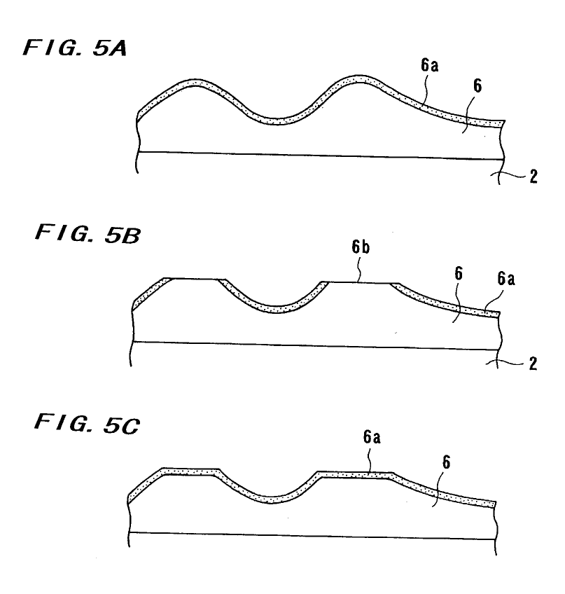

The copper film is effectively polished into flatness at a higher polishing rate than that of the conventional technique. In this regard, as described above, when the copper film is electropolished using the polishing liquid 12 containing a hydroxyquinoline and utilizing the copper as an anode, the copper reacts with the hydroxyquinoline to form an insoluble oxine-copper film 6a in the surface of copper film 6 as shown in FIG. 5A. The oxine-copper film 6a is quite fragile mechanically and can be easily polished away with a rotating low-pressure polishing tool. Accordingly, when carrying out polishing using the polishing tool 22, the oxine-copper film 6a formed in the surface of raised portions of copper film 6 is mainly polished away as shown in FIG. 5B, and the copper film 6 becomes exposed at the polished portions. The oxine-copper film 6a has a relatively high electric resistance, and therefore flowing of electric current through the portions covered with the oxine-copper film 6a is inhibited and the electric current is likely to concentrate on the metal-exposed portions 6b. Accordingly, as shown in FIG. 5C, a new oxine-copper film 6a immediately is formed in the polished exposed surface of copper film 6 and, as described above, the newly formed oxine-copper film 6a is mainly polished away. The surfaces of depressed portions of copper film 6 therefore remain covered with the oxine-copper film 6a, and polishing of such portions is inhibited. Accordingly, only the raised portions of copper film 6 are selectively polished away. The polishing is thus a composite electropolishing utilizing the passivation of copper.

During the polishing, the polishing liquid 12 is supplied from the long grooves 20a formed in the surface of the cathode plate 20 to between the substrate W and the polishing tool 22, and particles floating in the polishing liquid 12 and hydrogen gas, etc. generated by the reaction pass through the long grooves 20a and flow out to the exterior smoothly.

After completion of the polishing, the substrate W held by the substrate holder 16a is raised and rotation of the substrate W is stopped, and the substrate W after polishing is sent to a next step.

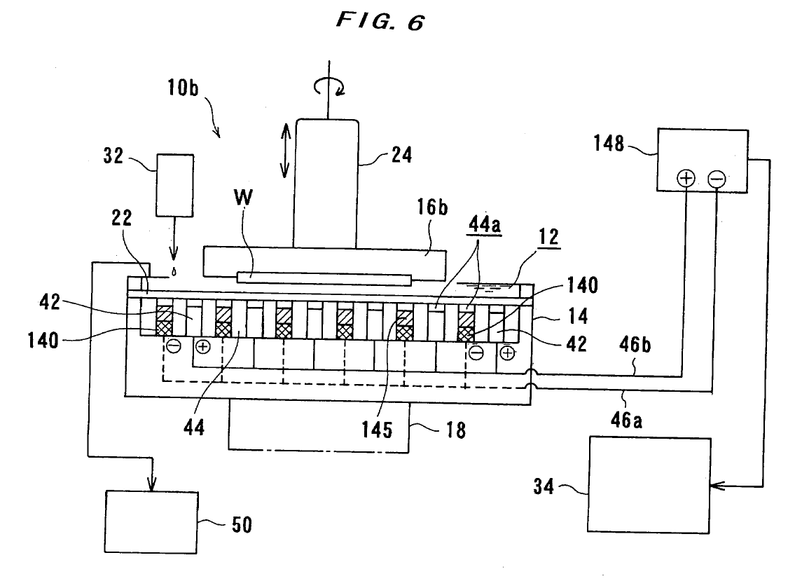

FIG. 6 shows a polishing apparatus 10b according to a second embodiment of the present invention. The polishing apparatus 10b differs from the above-described polishing apparatus 10a shown in FIG. 4 in that an electrode plate 44 made of an insulating material, having in its interior a number of cathode rods 140 and anode rods 42 disposed alternately, is disposed horizontally at the bottom of the polishing bath 14. In the upper surface of the electrode plate 44, a lattice form of long grooves 44a extending linearly and crosswise over the full length of the electrode plate 44 are formed. The cathode rods 140 are disposed along the long grooves 44a such that their upper surfaces almost coincide with the bottoms of the long grooves 44a, and the anode rods 42 are disposed along the long grooves 44a such that their upper surfaces lie e.g. 10-30 mm beneath the bottoms of the long grooves 44a. Porous fillers 145, each of which is permeable to flow gas bubbles generated to the polishing liquid, are filled in the spaces above the anode rods 42.

All the anode rods 42 are connected via a wire 46b to the anode terminal of an externally-disposed rectifier 148 as a direct-current and pulse-current power source, and all the cathode rods 140 are connected via a wire 46a to the cathode terminal of the rectifier 148.

A rectifier of low-voltage specification, having a capacity of about 100 V×10 A, for example, may be used as the rectifier 148. The frequency of pulse current may range from normal frequency to microsecond.

When a metal (copper) is disposed close to the electrode plate 44 and a voltage is applied from the rectifier 148 to between the cathode rods 140 and the anode rods 42 of the electrode plate 44, due to a bipolar phenomenon, positive polarity is created locally at the portion of the surface of the metal (copper) close to the cathode rods 140.

According to this embodiment, a polishing liquid regeneration unit 50 is provided for regenerating the polishing liquid 12 after recovering the polishing liquid that has overflowed the polishing bath 14 and has been filtered. Further, a substrate holder not having an electrical contact is employed as the substrate holder 16b.

The polishing apparatus 10b is suited for polishing barrier layer 5 and copper film 6 in the surface of a substrate W as shown in FIG. 10B, i.e. when the barrier layer 5 becomes exposed on the surface and the copper film 6 comes to take the shape of islands after a progress of polishing of extra copper film 6 deposited on the surface of the substrate W. Specifically, when the copper film 6 becomes the shape of islands, a uniform current-supplying from an external terminal, such as electrical contacts, to the copper film becomes impossible. Even in such a case, according to the polishing apparatus 10b of this embodiment, by making the surface of copper positive polar locally utilizing the bipolar phenomenon, an oxine-copper film can be formed on the surface of copper.

The polishing operation of the polishing apparatus 10b is the same as the above-described polishing apparatus 10a except for applying a voltage of e.g. 50 V between the cathode rods 140 and the anode rods 42 provided in the electrode plate 44 upon electropolishing.

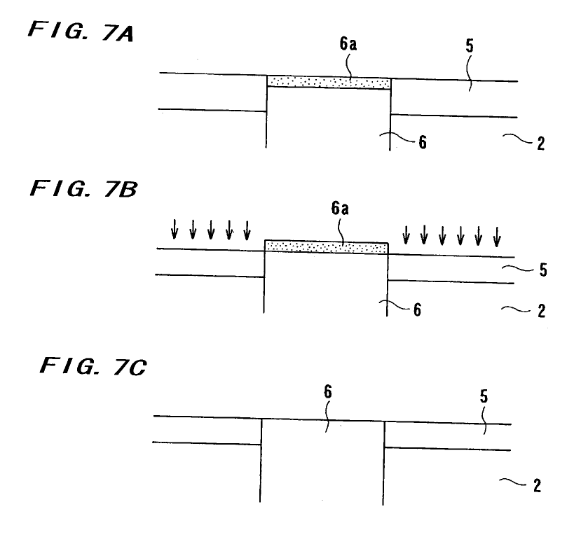

According to the polishing apparatus 10b, even when the barrier layer 5 and the copper film 6 are exposed on the surface, an excessive polishing of the copper film 6 can be prevented and the polishing rate of the remaining barrier layer 5 can be increased, making it possible to polish the both layers evenly at the same rate and prevent defects in the copper film 6 that becomes interconnects. In this regard, as described above, when the copper film 6 is electropolished using the polishing liquid 12 containing a hydroxyquinoline and utilizing the bipolar phenomenon to make the copper positive polar, the copper reacts with the hydroxyquinoline to form an insoluble oxine-copper film 6a on the surface of copper film 6 as shown in FIG. 7A. The oxine-copper film 6a does not dissolve in the electrolytic liquid, and therefore the copper film 6 covered with the oxine-copper film 6a does not undergo chemical etching. Accordingly, only the surface of barrier layer 5 is electropolished whereby the copper film 6 comes to protrude upward from the surface of the barrier layer 5. In the surface of the upwardly-protruding copper film 6, the oxine-copper film 6a which, as described above, is quite fragile mechanically and easy to polish away with a rotating low-pressure polishing tool. The oxine-copper film 6a can thus be polished away into flatness. Further, since the copper film 6 (oxine-copper film 6a) is polished away with the rotating low-pressure polishing tool 22, defects in the surface of copper film 6 can be prevented.

Before exposure of the barrier layer 5, as with the above-described polishing apparatus 10a, only the raised portions of copper film 6 are selectively polished away.

The composition of the first polishing liquid may differ from the composition of the second polishing liquid. In the second polishing step, it is necessary to polish the copper film and the barrier film, which differ in the electric conductivity, simultaneously at the same rate. A polishing liquid is therefore needed which passivates the copper film and, on the other hand, allows the barrier film to be mainly polished chemically.

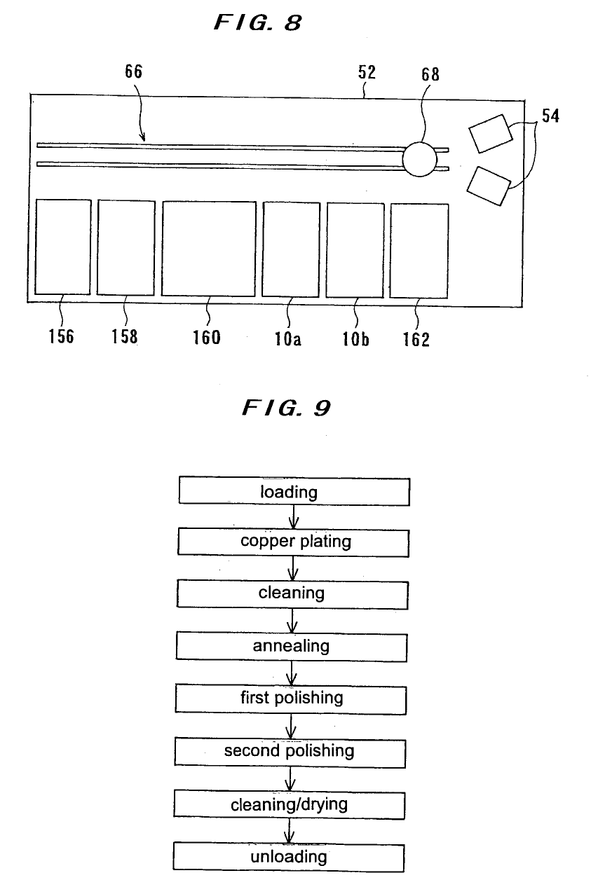

FIG. 8 is a layout plan of an interconnects-forming apparatus provided with the polishing apparatus 10a shown in FIG. 4 and the polishing apparatus 10b shown in FIG. 6. The interconnects-forming apparatus comprises, in a housing 52, loading/unloading sections 54 and, disposed in order from the farthest side of the loading/unloading sections 54, a copper plating apparatus 156, a cleaning apparatus 158, an annealing apparatus 160, the polishing apparatus (first polishing apparatus) 10a shown in FIG. 4, the polishing apparatus (second polishing apparatus) 10b shown in FIG. 6, and a cleaning/drying apparatus 162. The interconnects-forming apparatus is also provided with a transfer device 68 that can travel along a transfer route 66 and transfer a substrate between the above equipments.

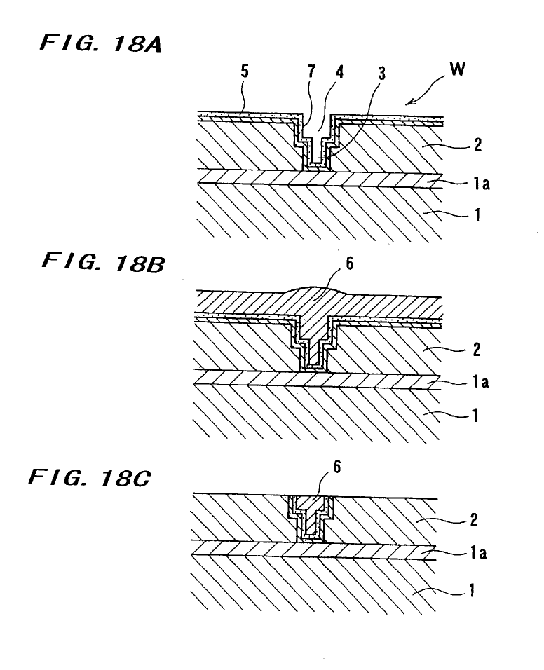

Interconnects-forming processing will now be described with reference to FIGS. 9 and 10. A substrate W having a seed layer 7 formed in the surface (see FIG. 18A) is taken one by one by the transfer device 68 out of the loading/unloading sections 54, and is carried in the copper plating apparatus 156. Copper electroplating, for example, is carried out in the copper plating apparatus 156, thereby forming a copper film 6 on the surface of the substrate W as shown in FIG. 10A.

Next, the substrate W after the copper plating is transferred to the cleaning apparatus 158 to clean the substrate W, and the cleaned substrate W is transferred to the annealing apparatus 160, where the substrate W with the copper film 6 deposited is heat-treated to anneal the copper film 6, and the annealed substrate is then transferred to the first polishing apparatus 10a.

In the first polishing apparatus 10a, a first polishing processing is carried out to the surface (plated surface) of the substrate W, thereby polishing the copper film 6 deposited on the upper surface of barrier layer 5. The first polishing is terminated when the film thickness of copper film 6 on the barrier layer 5 has reached a predetermined value. By thus carrying out the first polishing in the first polishing apparatus 10a, the polishing rate can be increased. Thereafter, the substrate W is transferred to the second polishing apparatus 10b to carry out a second polishing processing to the surface of the substrate W. In the second polishing, when the barrier layer 5 becomes exposed as shown in FIG. 10B, the barrier layer 5 on an insulating layer 2 and the surface of copper film 6 are polished simultaneously, so that the surface of insulating layer 2 becomes flush with the surface of interconnects consisting of the copper film 6, as shown in FIG. 10C. According to the second polishing apparatus 10b, by utilizing the bipolar phenomenon as in the conventional chemical mechanical polishing (CMP) to make the surface of copper positive polar locally, an oxine-copper film can be formed on the surface of copper. Accordingly, the polishing processing can be continued even when the barrier layer 5 becomes exposed and the copper film 6 becomes an island-like separated state.

The substrate after the polishing processing is transferred to the cleaning/drying apparatus 162 to clean and dry the substrate, and the dried substrate is returned to the original cassette in the loading/unloading sections 54 by the transfer device 68.

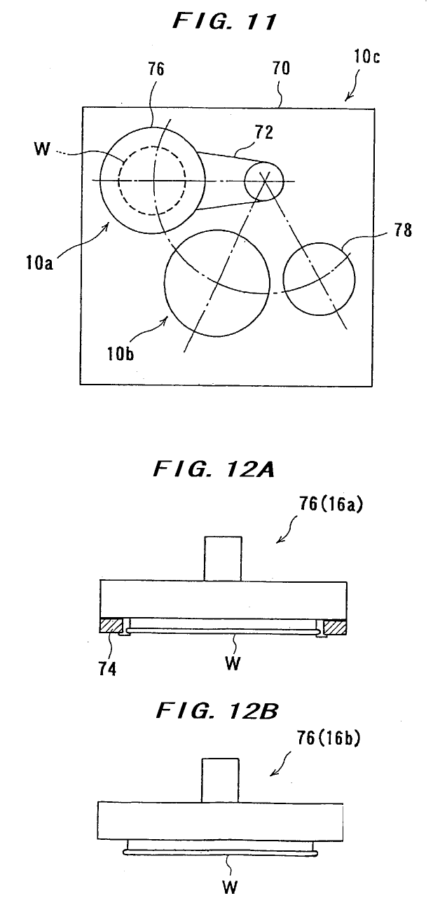

FIGS. 11 and 12 show a polishing apparatus 10c according to still another embodiment of the present invention. The polishing apparatus 10c includes the polishing apparatus (first polishing apparatus) 10a shown in FIG. 4 and the polishing apparatus (second polishing apparatus) 10b shown in FIG. 6, which are disposed in the same partitioned room, module 70. A pivotable arm 72, which transfers a substrate W between the first polishing apparatus 10a and the second polishing apparatus 10b, is provided in the room. More specifically, as shown in FIG. 12, the polishing apparatus 10c includes a substrate holder 76 which is provided with a detachable electrode ring 74 and coupled to the free end of the pivotable arm 72. The substrate holder 76 with the electrode ring 74 attached constitutes the substrate holder 16a of the first polishing apparatus 10a, and the substrate holder 76 without the electrode ring 74 constitutes the substrate holder 16b of the second polishing apparatus 10b, respectively. An electrode ring attachment/detachment stage 78 for attaching/detaching the electrode ring 74 is provided in the module 70.

According to this embodiment, the substrate is attracted and held by the substrate holder 76, to which the electrode ring 74 is attached, outside the module 70 and is then carried in the module 70. By the first polishing apparatus 10a including the substrate holder 76 with the electrode ring 74 attached, the same first polishing processing as described above is carried out. After completion of the first polishing processing, the substrate holder 76 with the substrate W held is moved to the electrode ring attachment/detachment stage 78, where the electrodering 74 is detached. By the second polishing apparatus 10b including the substrate holder 76 without the electrode ring 74, the same second polishing processing as described above is carried out. The substrate after the second polishing processing, held by the substrate holder 76, is carried out of the module 70.

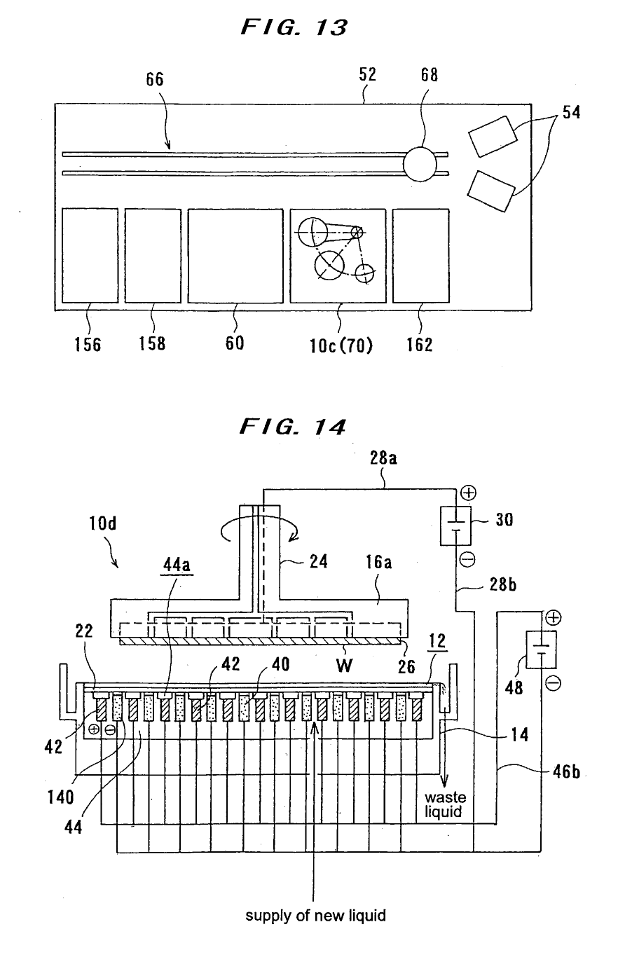

With the polishing apparatus 10c, which may be disposed at the placement position of the first polishing apparatus 10a and the second polishing apparatus 10b shown in FIG. 8, as shown in FIG. 13, a continuous interconnects-forming processing can be carried out.

FIGS. 14 through 16 show a polishing apparatus 10d according to still another embodiment of the present invention. The polishing apparatus 10d is so constructed that the above-described first polishing processing and the second polishing processing can be carried out in the same polishing bath. The polishing apparatus 10d differs from the above-described polishing apparatus 10b shown in FIG. 6 in that the apparatus 10d is provided with the substrate holder 16a and the rectifier (first rectifier) 30, which are provided in the polishing apparatus 10a shown in FIG. 4; the wire 28a extending from the anode of the first rectifier 30 is connected to the electrical contact 26 of the substrate holder 16a, and the wire 28b extending from the cathode of the first rectifier 30 is connected to the wire 46a extending from the cathode of the rectifier (second rectifier) 148; and the rectifiers 30, 148 are switchable.

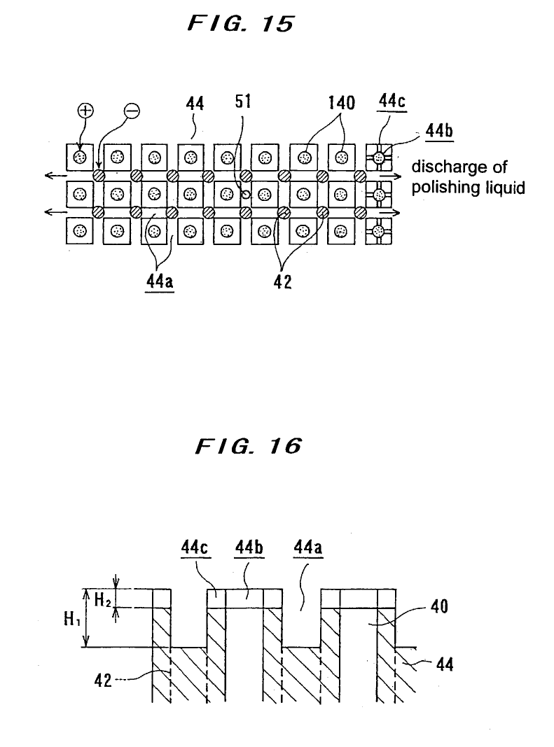

According to this embodiment, the polishing bath 14 is allowed to make a scroll movement. Further, a polishing liquid flow passage 51 (see FIG. 15), extending vertically through the polishing bath 14 and the electrode plate 44, is provided, and the polishing liquid 12 is supplied through the polishing liquid flow passage 51 into the polishing bath 14.

Long grooves 44a with a depth H₁ of e.g. about 3 mm are formed in the upper surface of the electrode plate 44. The bottoms of the long grooves 44a coincide with the upper surfaces of the anode rods 42. The cathode rods 140 are disposed in the central portions of the protruding square poles partitioned by the long grooves 44a. Further, depressed portions 44b with a depth H₂ of e.g. 1 mm are formed above the cathode rods 140. The depressed portions 44b communicate with the long grooves 44a via crosswise-extending communication grooves 44c.

The polishing liquid 12, supplied through the polishing liquid flow passage 51 into the polishing bath 14, flows along the long grooves 44a and flows through the communication grooves 44c into the depressed portions 44b. The polishing liquid 12 thus comes into contact with the upper surfaces of the cathode rods 140 and of the anode rods 42.

According to this embodiment, the above-described first polishing processing can be carried out by applying a voltage from the first rectifier 30 to between the electrical contacts 26 and the cathode rods 140 and, after switching the first rectifier 30 to the second rectifier 148, the above-described second polishing processing can be carried out by applying a voltage from the second rectifier 148 to between the cathode rods 140 and the anode rods 42.

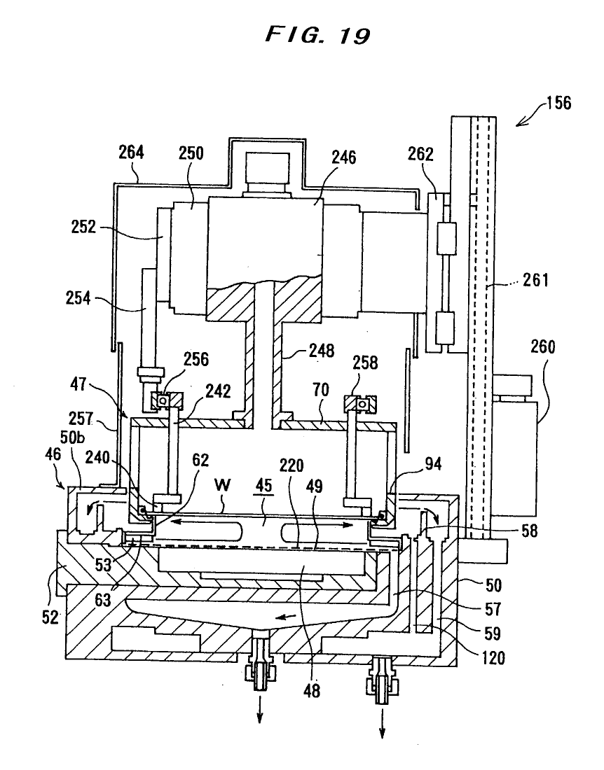

FIGS. 19 through 27 show a electroplating apparatus making-up the copper plating apparatus 156 provided in the apparatus shown in FIG. 8. As shown in FIG. 19, the electroplating apparatus is composed mainly of a plating process container 46 which is substantially cylindrical and contains a plating solution 45 therein, and a head 47 disposed above the plating process container 46 for holding the substrate W. In FIG. 19, the electroplating apparatus is in such a state that the substrate W is held by the head 47 and the surface of the plating solution 45 is on the liquid level for plating.

The plating process container 46 has a plating chamber 49 which is open upward and has an anode 48 at the bottom thereof. A plating bath 50 for containing the plating solution 45 is provided within the plating chamber 49. Plating liquid supply nozzles 53, which project horizontally toward the center of the plating chamber 49, are disposed at circumferentially equal intervals on the inner circumferential wall of the plating bath 50. The plating solution supply nozzles 53 communicate with plating solution supply passages extending vertically within the plating bath 50.

Further, according to this example, a punch plate 220 having a large number of holes with a size of, for example, about 3 mm is disposed at a position above the anode 48 within the plating chamber 49. The punch plate 220 prevents a black film formed on the surface of the anode 48 from curling up by the plating solution 45 and consequently being flowed out.

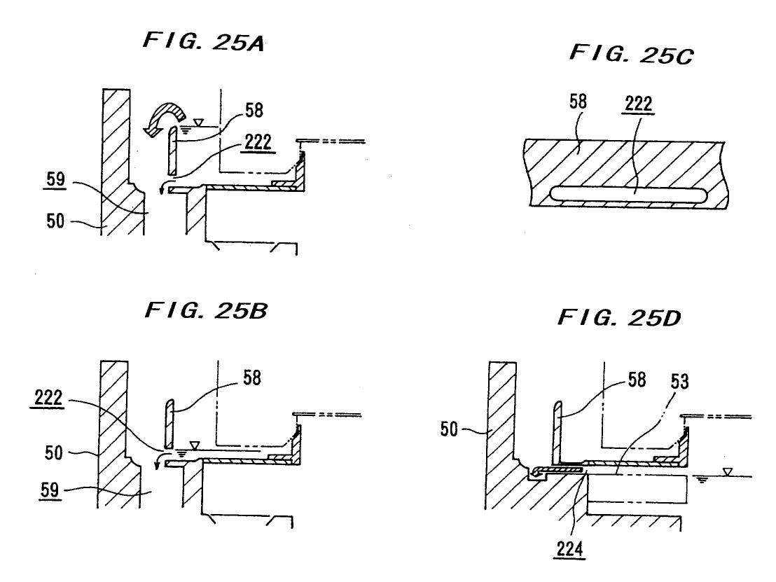

The plating bath 50 has first plating solution discharge ports 57 for withdrawing the plating solution 45 contained in the plating chamber 49 from the peripheral portion of the bottom in the plating chamber 49, and second plating solution discharge ports 59 for discharging the plating solution 45 which has overflowed a weir member 58 provided at the upper end of the plating bath 50. Further, the plating bath 50 has third plating solution discharge ports 120 for discharging the plating solution before overflowing the weir member 58. As shown in FIGS. 25A through 25C, the weir member 58 have, in its lower part, openings 222 having a predetermined width at predetermined intervals.

With this arrangement, when the amount of plating solution supplied is large during plating, the plating solution is discharged to the exterior through the third plating solution discharge ports 120 and, in addition, as shown in FIG. 25A, the plating solution overflowing the weir member 58 and passing through the openings 222 is discharged to the exterior through the second plating solution discharge ports 59. On the other hand, during plating, when the amount of plating solution supplied is small, the plating solution is discharged to the exterior through the third plating solution discharge ports 120, and as shown in FIG. 25B, the plating solution is passed through the openings 222 and discharged to the exterior through the second plating solution discharge ports 59. In this manner, this construction can easily cope with the case where the amount of plating solution supplied is large or small.

Further, as shown in FIG. 25D, through holes 224 for controlling the liquid level, which are located above the plating solution supply nozzles 53 and communicate with the plating chamber 49 and the second plating solution discharge ports 59, are provided at circumferentially predetermined pitches. Thus, when plating is not performed, the plating solution is passed through the through holes 224, and is discharged to the exterior through the second plating solution discharge ports 59, thereby controlling the liquid level of the plating solution. During plating, the through holes 224 serve as an orifice for restricting the amount of the plating solution flowing therethrough.

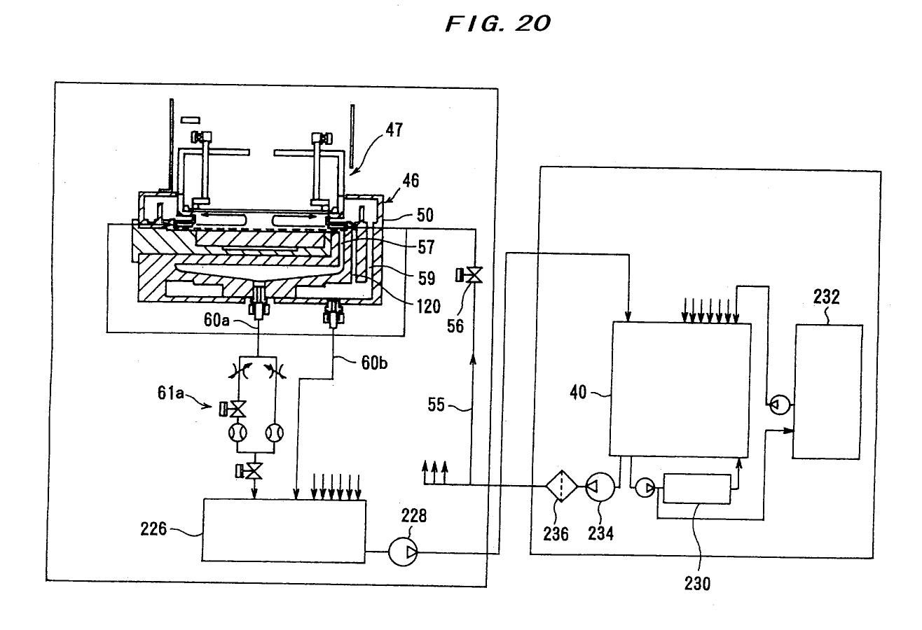

As shown in FIG. 20, the first plating solution discharge ports 57 are connected to the reservoir 226 through the plating solution discharge pipe 60a, and a flow controller 61a is provided in the midway portion of the plating solution discharge pipe 60a. The second plating solution discharge ports 59 and the third plating solution discharge ports 120 join with each other within the plating container 50, and the joined passage is then connected directly to the reservoir 226 through the plating solution discharge pipe 60b.

The plating solution 45 which has flowed into the reservoir 226 is introduced by a pump 228 into the plating solution regulating tank 40. This plating solution regulating tank 40 is provided with a temperature controller 230, and a plating solution analyzing unit 232 for sampling the plating solution and analyzing the sample plating solution. When a single pump 234 is operated, the plating solution is supplied from the plating solution regulating tank 40 through the filter 236 to the plating solution supply nozzles 53 of the copper plating apparatus 156. A control valve 56 for fixing the secondary pressure is provided in the midway portion of the plating solution supply pipe 55 extending from the plating solution regulating tank 40 to the copper plating apparatus 156.

Returning to FIG. 19, a vertical stream regulating ring 62 and a horizontal stream regulating ring 63, which is fixed to the plating bath 50, are disposed within the plating chamber 49 at a position near the internal circumference of the plating chamber 49, and the central portion of the liquid surface is pushed up by an upward stream out of two divided upward and downward streams of the plating solution 45 within the plating chamber 49, whereby the downward flow is smoothened and the distribution of the current density is further uniformized.

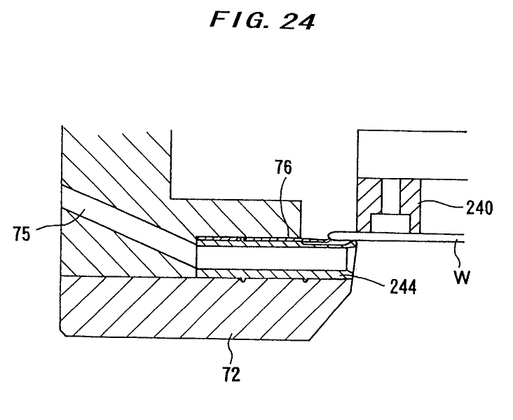

On the other hand, the head 47 comprises a housing 70 which is a rotatable and cylindrical receptacle having a downwardly open end and has openings 94 on the circumferential wall, and vertically movable pressing rods 242 having, in its lower end, a pressing ring 240. As shown in FIGS. 23 and 24, an inwardly projecting ring-shaped substrate holding member 72 is provided at the lower end of the housing 70. A ring-shaped sealing member 244 is mounted on the substrate holding member 72. The ring-shaped sealing member 244 projects inward, and the front end of the top surface in the ring-shaped sealing member 244 projects upward in an annular tapered form. Further, contacts 76 for a cathode electrode are disposed above the sealing member 244. Air vent holes 75, which extend outwardly in the horizontal direction and further extend outwardly in an upwardly inclined state, are provided in the substrate holding member 72 at circumferentially equal intervals.

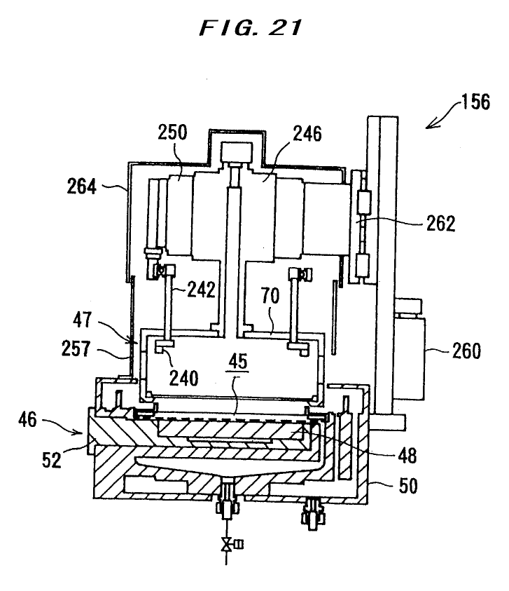

With this arrangement, as shown in FIG. 21, the liquid level of the plating solution is lowered, and as shown in FIGS. 23 and 24, the substrate W is held by a robot hand H or the like, and inserted into the housing 70 where the substrate W is placed on the upper surface of the sealing member 244 of the substrate holding member 72. Thereafter, the robot hand H is withdrawn from the housing 70, and the pressing ring 240 is then lowered to sandwich the peripheral portion of the substrate W between the sealing member 244 and the lower surface of the pressing ring 240, thereby holding the substrate W. In addition, upon holding of the substrate W, the lower surface of the substrate W is brought into pressure contact with the sealing member 244 to seal this contact portion positively. At the same time, current flows between the substrate W and the contacts 76 for a cathode electrode.

Returning to FIG. 19, the housing 70 is connected to an output shaft 248 of a motor 246, and rotated by the actuation of the motor 246. The pressing rods 242 are vertically provided at predetermined positions along the circumferential direction of a ring-shaped support frame 258 rotatably mounted through a bearing 256 on the lower end of a slider 254. The slider 254 is vertically movable by the actuation of a cylinder 252, with a guide, fixed to a support 250 surrounding the motor 246. With this construction, the pressing rods 242 are vertically movable by the actuation of the cylinder 252, and, in addition, upon the holding of the substrate W, the pressing rods 242 are rotated integrally with the housing 70.

The support 250 is mounted on a slide base 262 which is engaged with a ball screw 261 and vertically movable by the ball screw 261 rotated by the actuation of the motor 260. The support 250 is surrounded by an upper housing 264, and is vertically movable together with the upper housing 264 by the actuation of the motor 260. Further, a lower housing 257 for surrounding the housing 70 during plating is mounted on the upper surface of the plating container 50.

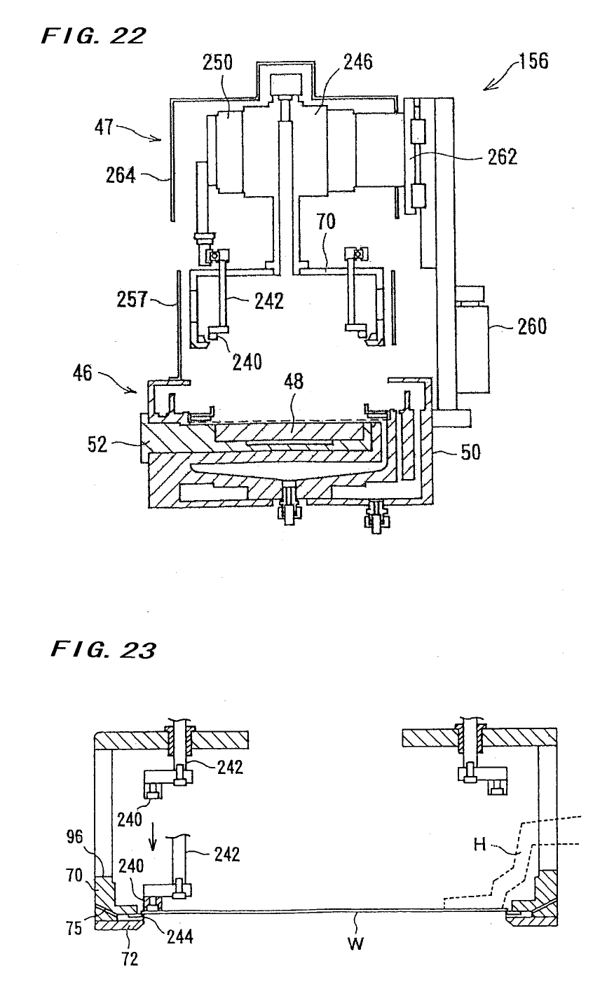

With this construction, as shown in FIG. 22, maintenance can be performed in such a state that the support 250 and the upper housing 264 are raised. A crystal of the plating solution is likely to deposit on the inner circumferential surface of the weir member 58. However, the support 250 and the upper housing 264 are raised, a large amount of the plating solution is flowed and overflows the weir member 58, and hence the crystal of the plating solution is prevented from being deposited on the inner circumferential surface of the weir member 58. A cover 50b for preventing the splash of the plating solution is integrally provided in the plating container 50 to cover a portion above the plating solution which overflows during plating process. By coating an ultra-water-repellent material such as HIREC (manufactured by NTT Advance Technology) on the lower surface of the cover 50b for preventing the splash of the plating solution, the crystal of the plating solution can be prevented from being deposited on the lower surface of the cover 50b.

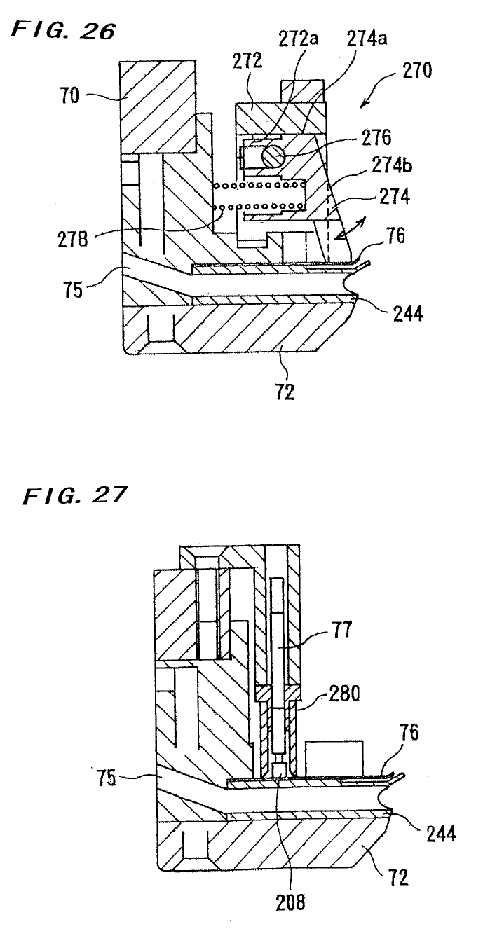

Substrate centering mechanisms 270 located above the substrate holding member 72 of the housing 70 for performing centering of the substrate W, are provided at four places along the circumferential direction in this embodiment. FIG. 26 shows the substrate centering mechanism 270 in detail. The substrate centering mechanism 270 comprises a gate-like bracket 272 fixed to the housing 70, and a positioning block 274 disposed within the bracket 272. This positioning block 274 is pivotably mounted through a support shaft 276 horizontally fixed to the bracket 272. Further, a compression coil spring 278 is interposed between the housing 70 and the positioning block 274. Thus, the positioning block 274 is urged by the compression coil spring 278 so that the positioning block 274 rotates about the support shaft 276 and the lower portion of the positioning block 274 projects inwardly. The upper surface 274a of the positioning block 274 serves as a stopper, and is brought into connect with the lower surface 272a of the bracket 272 to restrict the movement of the positioning block 274. Further, the positioning block 274 has a tapered inner surface 274b which is widened outward in the upward direction.

With this construction, a substrate is held by the hand of a transfer robot or the like, is carried into the housing 70, and is placed on the substrate holding member 72. In this case, when the center of the substrate deviates from the center of the substrate holding member 72, the positioning block 274 is rotated outwardly against the urging force of the compression coil spring 278 and, upon the release of holding of the substrate from the hand of the transfer robot or the like, the positioning block 274 is returned to the original position by the urging force of the compression coil spring 278. Thus, the centering of the substrate can be carried out.

FIG. 27 shows a feeding contact (a probe) 77 for feeding electricity to a cathode electrode plate 208 of a contact 76 for a cathode electrode. This feeding contact 77 is composed of a plunger and is surrounded by a cylindrical protective member 280 extending to the cathode electrode plate 208, whereby the feeding contact 77 is protected against the plating solution.

The plating operation of the copper plating apparatus (electroplating apparatus) 156 will now be described.

First, when transferring the substrate to the copper plating apparatus 156, the attracting hand of the transfer robot 68 shown in FIG. 8 and the substrate W attracted and held with its front surface facing downward by the attracting hand are inserted into the housing 70 through an opening 94, and the attracting hand is then moved downward. Thereafter, the vacuum attraction is released to place the substrate W on the substrate holder 72. The attracting hand is then moved upward and withdrawn from the housing 70. Thereafter, the pressure ring 240 is lowered down to the peripheral portion of the substrate W so as to hold the substrate W between the substrate holder 72 and the lower surface of the pressure ring 240.

The plating solution 45 is then jetted from the plating solution jet nozzles 53 while, at the same time, the housing 70 and the substrate W held by it are allowed to rotate at a middle speed. When the plating bath is charged with a predetermined amount of plating solution 45, and further after an elapse of several seconds, the rotational speed of the housing 70 is decreased to a slow rotation (e.g. 100 min⁻¹). Then, electroplating is carried out by flowing an electric current between the anode 48 and the plating surface of the substrate as a cathode.

After the application of the electric current, as shown in FIG. 25D, the feed of the plating solution is decreased so that the plating solution is allowed to flow out only through the through holes 224 for liquid level control positioned above the plating solution jet nozzles 53, thereby exposing the housing 70, together with the substrate W held by it, above the surface of the plating solution. The housing 70 and the substrate W, positioned above the solution surface, are allowed to rotate at a high speed (e.g. 500-800 min⁻¹) to drain off the plating solution by the action of centrifugal force. After completion of the draining, the rotation of the housing 70 is stopped so that the housing 70 stops facing at a predetermined direction.

After the housing 70 comes to a complete stop, the pressure ring 240 is moved upward. Thereafter, the attracting hand of the transfer robot 28b is inserted, with its attracting face downward, into the housing 70 through the opening 94 and is then lowered to a position at which the attracting hand can attract the substrate. After attracting the substrate by vacuum attraction, the attracting hand is moved upward to the position of the opening 94 of the housing 70, and is withdrawn, together with the substrate held by the hand, through the opening 94.

According to the copper plating apparatus 156, the head section 47 can be designed to be compact and structurally simple. Further, the plating can be carried out when the surface of the plating solution 45 in the plating treatment bath 46 is at the plating level, and the draining and the transfer of the substrate can be conducted when the surface of the plating solution is at the substrate-transfer level. Moreover, the black film formed on the surface of the anode 48 can be prevented from being dried and oxidized.

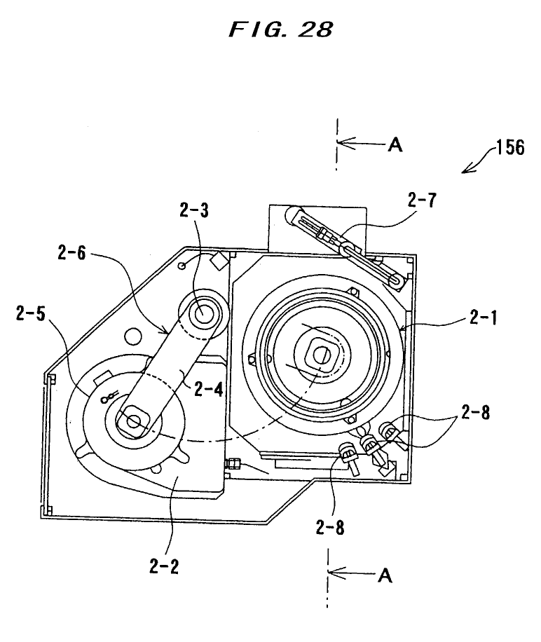

FIGS. 28 through 33 show another electroplating apparatus making-up the copper plating apparatus 156. The copper plating apparatus 156, as shown in FIG. 28, is provided with a substrate treatment section 2-1 for performing plating treatment and its attendant treatment, and a plating solution tray 2-2 for storing a plating solution is disposed adjacent to the substrate treatment section 2-1. There is also provided an electrode arm portion 2-6 having an electrode portion 2-5 which is held at the front end of an arm 2-4 swingable about a rotating shaft 2-3 and which is swung between the substrate treatment section 2-1 and the plating solution tray 2-2.

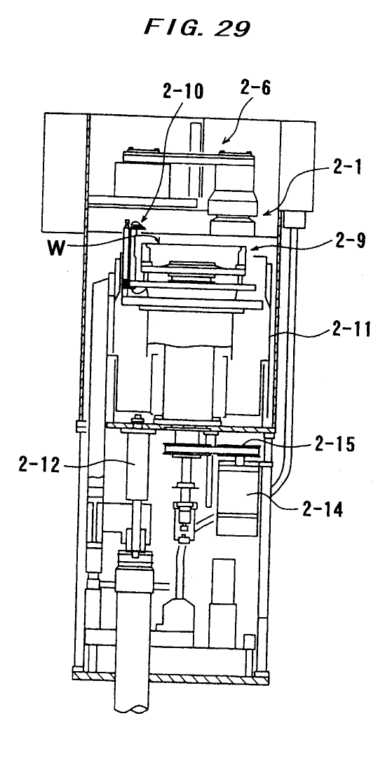

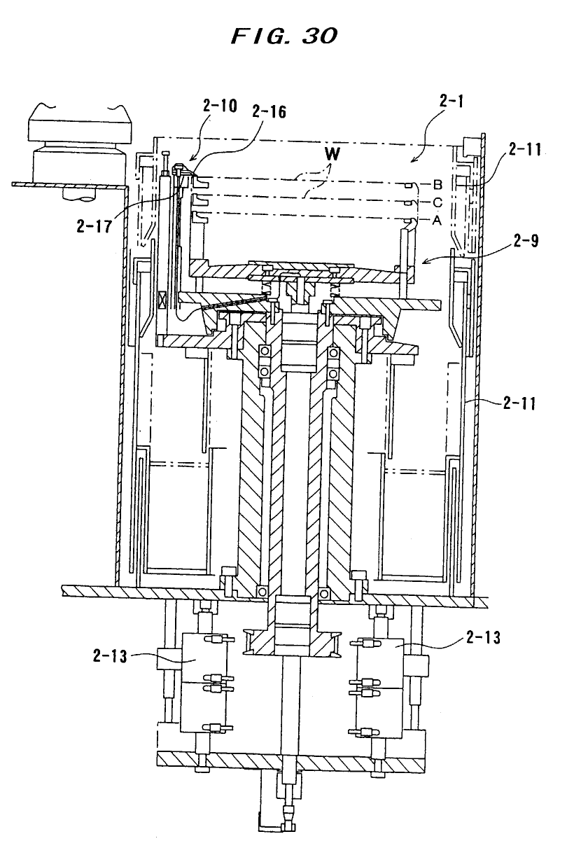

Furthermore, a precoating/recovery arm 2-7, and fixed nozzles 2-8 for ejecting pure water or a chemical liquid such as ion water, and further a gas or the like toward a substrate are disposed laterally of the substrate treatment section 2-1. In this case, three of the fixed nozzles 2-8 are disposed, and one of them is used for supplying pure water. The substrate treatment section 2-1, as shown in FIGS. 29 and 30, has a substrate holding portion 2-9 for holding a substrate W with its surface to be plated facing upward, and a cathode portion 2-10 located above the substrate holding portion 2-9 so as to surround a peripheral portion of the substrate holding portion 2-9. Further, a substantially cylindrical bottomed cup 2-11 surrounding the periphery of the substrate holding portion 2-9 for preventing scatter of various chemical liquids used during treatment is provided so as to be vertically movable by an air cylinder 2-12.

The substrate holding portion 2-9 is adapted to be raised and lowered by the air cylinder 2-12 among a lower substrate transfer position A, an upper plating position B, and a pretreatment and cleaning position C intermediate between these positions. The substrate holding portion 2-9 is also adapted to rotate at an arbitrary acceleration and an arbitrary velocity integrally with the cathode portion 2-10 by a rotating motor 2-14 and a belt 2-15. A substrate carry-in and carry-out opening (not shown) is provided in confrontation with the substrate transfer position A in a frame side surface of the electroplating apparatus facing the transferring robot (not shown). When the substrate holding portion 2-9 is raised to the plating position B, a seal member 2-16 and cathode electrodes 2-17 of the cathode portion 2-10 are brought into contact with the peripheral edge portion of the substrate W held by the substrate holding portion 2-9. On the other hand, the cup 2-11 has an upper end located below the substrate carry-in and carry-out opening, and when the cup 2-11 ascends, the upper end of the cup 2-11 reaches a position above the cathode portion 2-10, as shown by imaginary lines in FIG. 30.

When the substrate holding portion 2-9 has ascended to the plating position B, the cathode electrode 2-17 is pressed against the peripheral edge portion of the substrate W held by the substrate holding portion 2-9 for thereby allowing electric current to flow through the substrate W. At the same time, an inner peripheral end portion of the seal member 2-16 is brought into contact with an upper surface of the peripheral edge of the substrate W under pressure to seal its contact portion in a watertight manner. As a result, the plating solution supplied onto the upper surface of the substrate W is prevented from seeping from the end portion of the substrate W, and the plating solution is prevented from contaminating the cathode electrode 2-17.

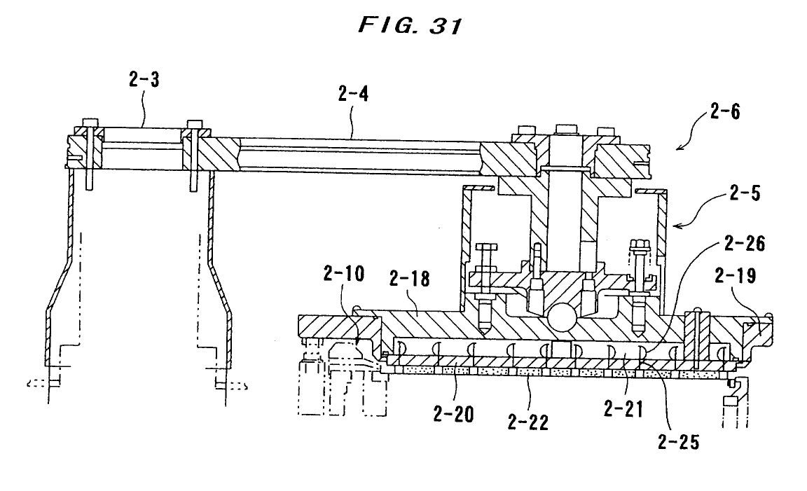

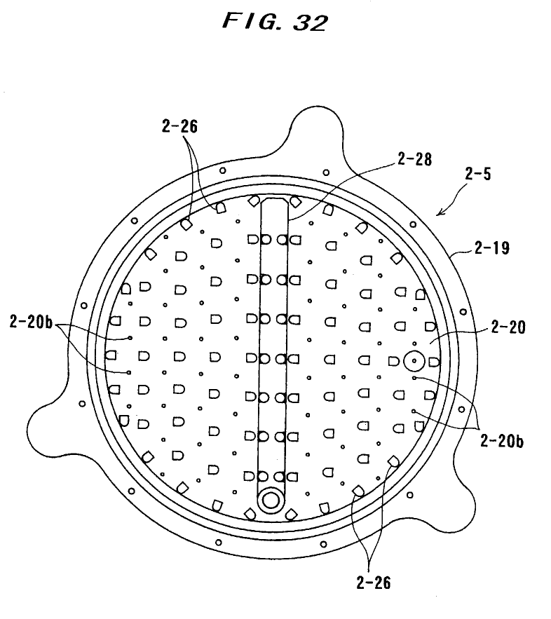

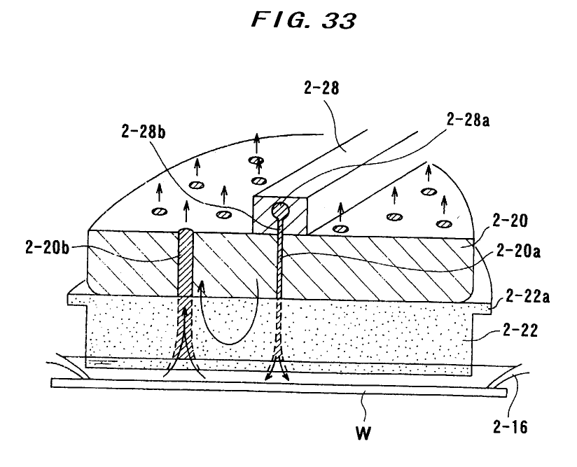

As shown in FIG. 31, an electrode portion 2-5 of the electrode arm portion 2-6 has a housing 2-18 at a free end of a pivoting arm 2-4, a hollow support frame 2-19 surrounding the housing 2-18, and an anode 2-20 fixed by holding the peripheral edge portion of the anode 2-20 between the housing 2-18 and the support frame 2-19. The anode 2-20 covers an opening portion of the housing 2-18, and a suction chamber 2-21 is formed inside the housing 2-18. Further, as shown in FIGS. 32 and 33, a plating solution introduction pipe 2-28 and a plating solution discharge pipe (not shown) for introducing and discharging the plating solution are connected to the suction chamber 2-21. Further, many passage holes 2-20b communicating with regions above and below the anode 2-20 are provided over the entire surface of the anode 2-20.

In this embodiment, a plating solution impregnated material 2-22 comprising a water retaining material and covering the entire surface of the anode 2-20 is attached to the lower surface of the anode 2-20. The plating solution impregnated material 2-22 is impregnated with the plating solution to wet the surface of the anode 2-20, thereby preventing a black film from falling onto the plated surface of the substrate, and simultaneously facilitating escape of air to the outside when the plating solution is poured between the surface, to be plated, of the substrate and the anode 2-20. The plating solution impregnated material 2-22 comprises, for example, a woven fabric, nonwoven fabric, or sponge-like structure comprising at least one material of polyethylene, polypropylene, polyester, polyvinyl chloride, Teflon, polyvinyl alcohol, polyurethane, and derivatives of these materials, or comprises a porous ceramics.

Attachment of the plating solution impregnated material 2-22 to the anode 2-20 is performed in the following manner. That is, many fixing pins 2-25 each having a head portion at the lower end are arranged such that the head portion is provided in the plating solution impregnated material 2-22 so as not to be releasable upward and a shaft portion of the fixing pin 2-25 pierces the interior of the anode 2-20, and the fixing pins 2-25 are urged upward by U-shaped leaf springs 2-26, whereby the plating solution impregnated material 2-22 is brought in close contact with the lower surface of the anode 2-20 by the resilient force of the leaf springs 2-26 and is attached to the anode 2-20. With this arrangement, even when the thickness of the anode 2-20 gradually decreases with the progress of plating, the plating solution impregnated material 2-22 can be reliably brought in close contact with the lower surface of the anode 2-20. Thus, it can be prevented that air enters between the lower surface of the anode 2-20 and the plating solution impregnated material 2-22 to cause poor plating.

Incidentally, columnar pins made of PVC (polyvinyl chloride) or PET (polyethylene terephthalate) and having a diameter of, for example, about 2 mm may be arranged from the upper surface side of the anode so as to pierce the anode, and an adhesive may be applied to the front end surface of each of the pins projecting from the lower surface of the anode to fix the plating solution impregnated material. The anode and the plating solution impregnated material may be used in contact with each other, but it is also possible to provide a gap between the anode and the plating solution impregnated material, and perform plating treatment while holding the plating solution in the gap. This gap is selected from a range of 20 mm or less, but is preferably selected from a range of 0.1 to 10 mm, and more preferably 1 to 7 mm. Particularly, when a soluble anode is used, the anode is dissolved from its lower portion. Thus, as time passes, the gap between the anode and the plating solution impregnated material enlarges and forms a gap in the range of 0 to about 20 mm.

The electrode portion 2-5 descends to such a degree that when the substrate holding portion 2-9 is located at the plating position B (see FIG. 30), the gap between the substrate W held by the substrate holding portion 2-9 and the plating solution impregnated material 2-22 reaches about 0.1 to 10 mm, preferably 0.3 to 3 mm, and more preferably about 0.5 to 1 mm. In this state, the plating solution is supplied from a plating solution supply pipe to be filled between the upper surface (surface to be plated) of the substrate W and the anode 2-20 while the plating solution impregnated material 2-22 is impregnated with the plating solution. The surface, to be plated, of the substrate W is plated by applying a voltage from a power source to between the upper surface (surface to be plated) of the substrate W and the anode 2-20.

The plating treatment carried out in the copper plating apparatus (electroplating apparatus) 156 will now be described.

First, a substrate W is transferred by the transfer robot 68 (see FIG. 8) to the substrate holder 2-9 at the substrate transfer position A and placed on the substrate holder 2-9. The cup 2-11 is then raised and, at the same time, the substrate holder 2-9 is raised to the pretreatment/cleaning position C. The precoating/recovering arm 2-7 in the retreat position is moved to a position where the precoating/recovering arm 2-7 faces the substrate W, and a precoating solution, comprising e.g. a surfactant, is intermittently ejected from a precoating nozzle provided at the end of the precoating/recovering arm 2-7 onto the plating surface of the substrate W. The precoating is carried out while rotating the substrate holder 2-9, so that the precoating solution can spread over the entire surface of the substrate W. After completion of the precoating, the precoating/recovering arm 2-7 is returned to the retreat position, and the rotational speed of the substrate holder 2-9 is increased to scatter by centrifugal force the precoating solution on the plating surface of the substrate W to thereby dry the substrate.

Subsequently, after the substrate holding portion 2-9 is raised to the plating position C, the electrode arm section 2-6 is swung horizontally so that the electrode portion 2-5 moves from above the plating solution tray 2-2 to above a position for plating, and then the electrode portion 2-5 is lowered toward the cathode portion 2-10. After the electrode portion 2-5 has reached the plating position, a plating voltage is applied between the anode 2-20 and the cathode portion 2-10, while a plating solution is fed into the electrode portion 2-5 and supplied to the plating solution impregnated material 2-22 through a plating solution supply slot penetrating the anode 2-20. At this time, the plating solution impregnated material 2-22 is not in contact with but close to the plating surface of the substrate W generally at a distance of about 0.1 to 10 mm, preferably about 0.3 to 3 mm, more preferably about 0.5 to 1 mm.

When the supply of the plating solution is continued, the plating solution containing copper ions, oozing out of the plating solution impregnated material 2-22, comes to fill the interstice between the plating solution impregnated material 2-22 and the plating surface of the substrate W, whereupon copper plating of the plating surface of the substrate W starts. At this time, the substrate holder 2-9 may be rotated at a low speed.

After completion of the plating treatment, the electrode arm section 2-6 is raised and then swung so that the electrode portion 2-5 is returned to above the plating solution tray 2-2, and the electrode portion 2-5 is then lowered to the normal position. Next, the precoating/recovering arm 2-7 is moved from the retreat position to the position where the arm faces the substrate W. The precoating/recovering arm 2-7 is then lowered, and the plating solution remaining on the substrate W is recovered through a plating solution-recovering nozzle (not shown). After completion of the recovery of the remaining plating solution, the precoating/recovering arm 2-7 is returned to the retreat position. Thereafter, pure water is ejected toward the center of the substrate W and, at the same time, the Substrate holder 2-9 is rotated at a high speed, thereby replacing the plating solution on the surface of the substrate W with pure water.

After the above rinsing treatment, the substrate holder 2-9 is lowered from the plating position B to the pretreatment/cleaning position C, where water-washing Of the substrate is carried out by supplying pure water from the fixed nozzle 2-8 for pure water supply while rotating the substrate holder 2-9 and the cathode portion 2-10. In this treatment, the sealing member 2-16 and the cathode electrode 2-17 can als cleaned, simultaneously with the substrate W, by the pure water supplied directly to the cathode portion 2-10 or by the pure water scattered from the surface of the substrate W.

After completion of the water-washing, the supply of pure water from the fixed nozzle 2-8 is stopped, and the rotation a speed of the substrate holder 2-9 and the cathode portion 2-10 is increased to scatter by centrifugal force the pure water on the surface of the substrate W to thereby dry the substrate. Simultaneously therewith, the sealing member 2-16 and the cathode electrode 2-17 can also be dried. After the drying, the rotation of the substrate holder 2-9 and the cathode portion 2-10 is stopped, and the substrate holder 2-9 is lowered to the substrate transfer Position A.

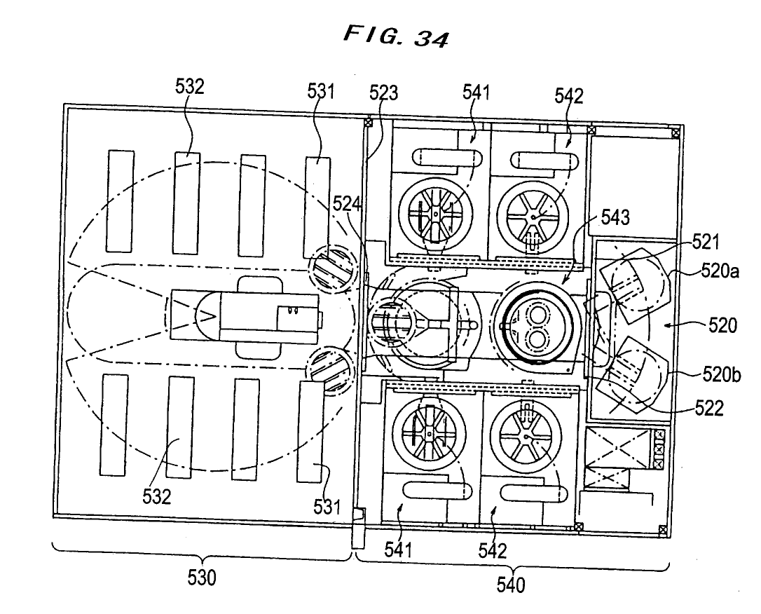

FIG. 34 is a layout plan of a substrate processing apparatus provided with the electroplating apparatus described above. As shown in FIG. 34, the substrate processing apparatus comprises a loading and unloading area 520 for housing substrate cassettes which accommodate semiconductor substrates, a processing area 530 for processing semiconductor substrates, and a cleaning and drying area 540 for cleaning and drying processed semiconductor substrates. The cleaning and drying area 540 is positioned between the loading and unloading area 520 and the processing area 530. A partition 521 is disposed between the loading and unloading area 520 and the cleaning and drying area 540, and a partition 523 is disposed between the cleaning and drying area 540 and the processing area 530.

The partition 521 has a passage (not shown) defined therein for transferring semiconductor substrates therethrough between the loading and unloading area 520 and the cleaning and drying area 540, and supports a shutter 522 for opening and closing the passage. The partition 523 has a passage (not shown) defined therein for transferring semiconductor substrates therethrough between the cleaning and drying area 540 and the processing area 530, and supports a shutter 524 for opening and closing the passage. The cleaning and drying area 540 and the processing area 530 can independently be supplied with and discharge air.

The substrate processing apparatus for forming interconnects of the semiconductor substrate described above is Placed in a clean room. The pressures in the loading and unloading area 520, the processing area 530, and the cleaning and drying area 540 are selected as follows:

Pressure in the loading and unloading area 520>Pressure in the cleaning and drying area 540>Pressure in the processing area 530

The pressure in the loading and unloading area 520 is lower than the pressure in the clean room. Therefore, air does not flow from the processing area 530 into the cleaning and drying area 540, and air does not flow from the cleaning and drying area 540 into the loading and unloading area 520. Furthermore, air does not flow from the loading and unloading area 520 into the clean room.

In the loading and unloading area 520, a loading unit 520a and an unloading unit 520b, each accommodating a substrate cassette for storing semiconductor substrates, are disposed. The cleaning and drying area 540 is provided with two water cleaning units 541 for processing plated semiconductor substrates, two drying units 542, and transfer portion (transfer robot) 543 for transferring the substrates. Each of the water cleaning units 541 may comprise a pencil-shaped cleaner with a sponge layer mounted on a front end thereof or a roller with a sponge layer mounted on an outer circumferential surface thereof. Each of the drying units 542 may comprise a drier for spinning a semiconductor substrate at a high speed to dehydrate and dry.

The processing area 530 houses a plurality of pretreatment chambers 531 for pretreating semiconductor substrates prior to being plated, and a plurality of plating chambers (plating apparatus) 532 for plating semiconductor substrates with copper. The processing area 530 also has a transfer portion (transfer robot) 533 for transferring semiconductor substrates.

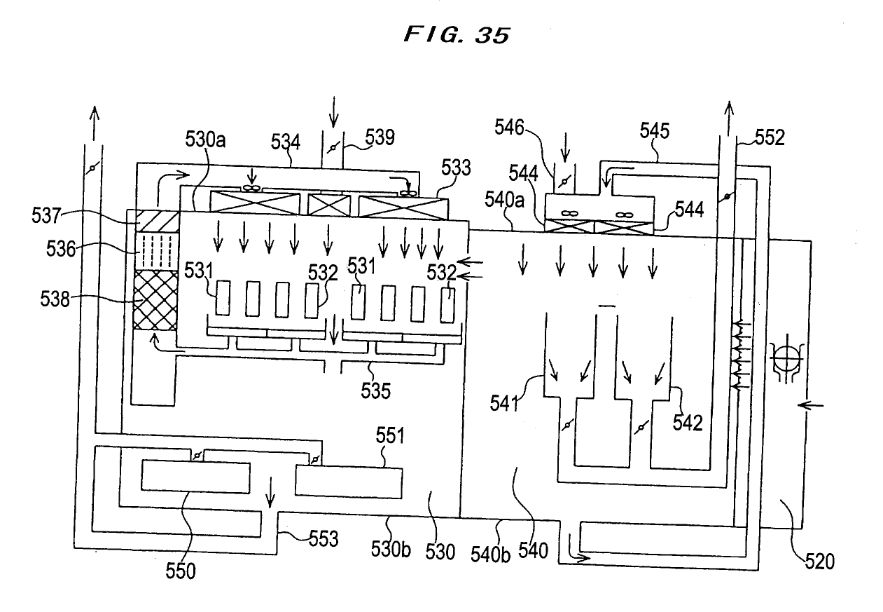

FIG. 35 shows airflows in the substrate processing apparatus. In the cleaning and drying area 540, a fresh air is introduced from the exterior through a duct 546 and forced through high-performance filters 544 by fans from a ceiling 540a into the cleaning and drying area 540 as downward clean air flows around the water cleaning units 541 and the drying units 542. Most of the supplied clean air is returned from a floor 540b through a circulation duct 545 to the ceiling 540a, from which the clean air is forced again through the filters 544 by the fans into the cleaning and drying area 540. Part of the clean air is discharged from the wafer cleaning units 541 and the drying units 542 through a duct 552.

In the processing area 530, particles are not allowed to be applied to the surfaces of semiconductor substrates even though the processing area 530 is a wet zone. To prevent particles from being applied to semiconductor substrates, air is forced through high-performance filters 533 by fans from a ceiling 530a into the processing area 530 so as to form downward clean air flows.

If the entire amount of clean air as downward clean air flows were always supplied from the exterior, then a large amount of air would be required. Accordingly, air is discharged from the room through a duct 553 at a rate sufficient enough to keep negative pressure in the room, and most of the downward clean air introduced into the room is circulated through circulation ducts 534, 535.

The clean air that has passed through the processing area 530 contains a chemical mist and gases, if circulation air is employed. The chemical mist and gases are removed from the circulating air by a scrubber 536 and mist separators 537, 538. The air returned into the circulation duct 534 over the ceiling 530a is free of any chemical mist and gases. The clean air is then forced through the filters 533 by the fans to circulate back into the processing area 530.

Part of the air is discharged from the processing area 530 through the duct 553 connected to a floor 530b. Air containing a chemical mist and gases is also discharged from the processing area 530, through the duct 553. The amount of fresh air, which corresponds to the discharged air, is introduced from the exterior through a duct 539 of the ceiling 530a into the processing area 530 so as to maintain negative pressure in the processing area 530.

As described above, the pressure in the loading and unloading area 520 is higher than the pressure in the cleaning and drying area 540 which is higher than the pressure in the processing area 530. When the shutters 522, 524 (see FIG. 34) are opened, therefore, air flows successively through the loading and unloading area 520, the cleaning and drying area 540, and the processing area 530. Air discharged flows through the ducts 552, 553 into a common duct 554, as shown in FIG. 37.

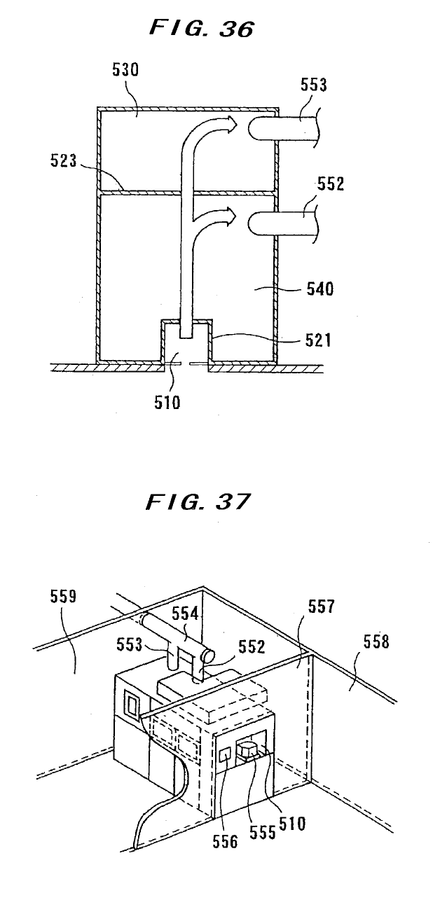

FIG. 36 is a perspective view of the substrate processing apparatus, which is placed in the clean room. The loading and unloading area 520 includes a side wall which has a cassette transfer port 555 defined therein and a control panel 556, and which is exposed to a working zone 558 that is compartmented in the clean room by a partition wall 557. Other sidewalls of the substrate processing apparatus are exposed to the utility zone 559.

As described above, the cleaning and drying area 540 is disposed between the loading and unloading area 520 and the processing area 530. The partition 521, 523 are disposed between the loading and unloading area 520 and the cleaning and drying area 540, and between the cleaning and drying area 540 and the processing area 530. A dry semiconductor substrate is loaded from the working zone 558 through the cassette transfer port 555 into the substrate processing apparatus, and then plated in the substrate processing apparatus. The plated semiconductor substrate is cleaned and dried, and then unloaded from the substrate processing apparatus through the cassette transfer port 555 into the working zone 558. Consequently, no particles and mist are applied to the surface of the semiconductor substrate, and the working zone 558 which has higher air cleanness than the utility zone 557 is prevented from being contaminated by particles, chemical mists, and cleaning solution mists.

In the example shown in FIGS. 34 and 35, the substrate processing apparatus has the loading and unloading area 520, the cleaning and drying area 540, and the processing area 530. However, an area accommodating a CMP unit may be disposed in or adjacent to the processing area 530, and the cleaning and drying area 540 may be disposed in the processing area 530 or between the area accommodating the CMP unit and the loading and unloading area 520. Any of various other suitable area and unit layouts may be employed insofar as a dry state semiconductor substrate can be loaded into the substrate processing apparatus, and a plated semiconductor substrate can be cleaned and dried, and thereafter unloaded from the substrate processing apparatus.

In the embodiment described above, the substrate processing apparatus is adapted to the plating apparatus for forming interconnects of the semiconductor substrate. However, the substrate is not limited to the semiconductor substrate. The portion to be plated is not also limited to interconnection region in the surface of the substrate. The embodiment adapted to copper plating is described above, it is clear not to be limited to copper plating.

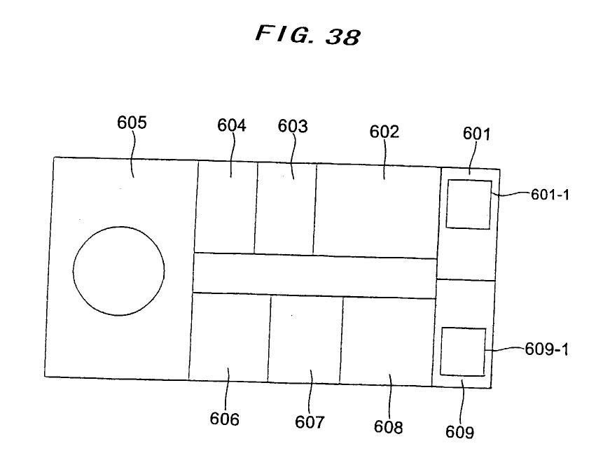

FIG. 38 is a plan view of another example of a substrate processing apparatus for forming interconnects of the semiconductor substrate. The substrate processing apparatus for forming interconnects of the semiconductor substrate shown in FIG. 38 comprises a loading unit 601 for loading a semiconductor substrate, a copper plating chamber 602 for plating a semiconductor substrate with copper, water cleaning chambers 603, 604 for cleaning a semiconductor substrate with water, a CMP unit 605 for chemically and mechanically polishing (CMP) a semiconductor substrate, water cleaning chambers 606, 607, a drying chamber 608, and an unloading unit 609 for unloading a semiconductor substrate with an interconnection film thereon. The substrate processing apparatus also has a substrate transfer mechanism (not shown) for transferring semiconductor substrates between the above equipment as a single apparatus so as to compose a substrate processing apparatus for forming interconnects of the semiconductor substrate.

The substrate processing apparatus operates as follows. The substrate transfer mechanism transfers a semiconductor substrate on which an interconnection film has not yet been formed from a substrate cassette 601-1 placed in the loading unit 601 to the copper plating chamber 602. In the copper plating chamber 602, a plated copper film is formed on a surface of the semiconductor substrate W having an interconnection region composed of an interconnection trench and an interconnection hole (contact hole).

After the plated copper film is formed on the semiconductor substrate W in the copper plating chamber 602, the semiconductor substrate W is transferred to the water cleaning chambers 603, 604 by the substrate transfer mechanism, in which the semiconductor substrate W is cleaned by water. The cleaned semiconductor substrate W is transferred to the CMP unit 605 by the substrate transfer mechanism. The CMP unit 605 removes the unwanted plated copper film from the surface of the semiconductor substrate W, leaving a portion of the plated copper film in the interconnection trench and the interconnection hole.

Then, the semiconductor substrate W with the remaining plated copper film is transferred to the water cleaning chambers 606, 607 by the substrate transfer mechanism, in which the semiconductor substrate W is cleaned by water. The cleaned semiconductor substrate W is then dried in the drying chamber 608, after which the dried semiconductor substrate W with the remaining plated copper film serving as an interconnection film is placed into a substrate cassette 609-1 in the unloading unit 609.

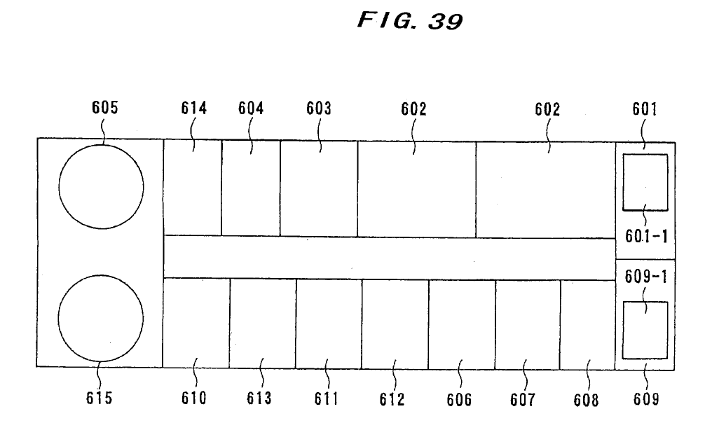

FIG. 39 shows a plan view of still another example of a substrate processing apparatus for forming interconnects of the semiconductor substrate. The substrate processing apparatus shown in FIG. 39 differs from the substrate processing apparatus shown in FIG. 38 in that it additionally includes a copper plating chamber 602, a water cleaning chamber 610, a pretreatment chamber 611, a cap plating chamber 612 for forming a protective plated layer on a surface of a plated copper film, water cleaning chambers 613, 614, a CMP unit 615. The above equipments are combined into a single unitary arrangement as an apparatus.

In the substrate processing apparatus described above, a plated copper film is formed on a surface of a semiconductor substrate W having an interconnection region composed of an interconnection trench and an interconnection hole (contact hole). Then, the CMP unit 605 removes the plated copper film from the surface of the semiconductor substrate W, leaving a portion of the plated copper film in the interconnection trench and the interconnection hole.

Thereafter, the semiconductor substrate W with the remaining plated copper film is transferred to the water cleaning chamber 610, in which the semiconductor substrate W is cleaned with water. Then, the semiconductor substrate W is transferred to the pretreatment chamber 611, in which the semiconductor substrate W pretreated for the cap plating. The pretreated semiconductor substrate W is transferred to the cap plating chamber 612. In the cap plating chamber 612, a protective plated layer is formed on the plated copper film in the interconnection region on the semiconductor substrate W. For example, the protective plated layer is formed with an alloy of nickel (Ni) and boron (B) by electroless plating. After the protective plated layer is formed on the plated copper film, the semiconductor substrate is cleaned in the water cleaning chambers 606, 607 and dried in the drying chamber 608.

Then, an upper portion of the protective plated layer deposited on the plated copper film is polished off to flatten the protective plated layer, in the CMP unit 615. Thereafter, the semiconductor substrate W is cleaned by water in the water cleaning chambers 613, 614, dried in the drying chamber 608, and then transferred to the substrate cassette 609-1 in the unloading unit 609.

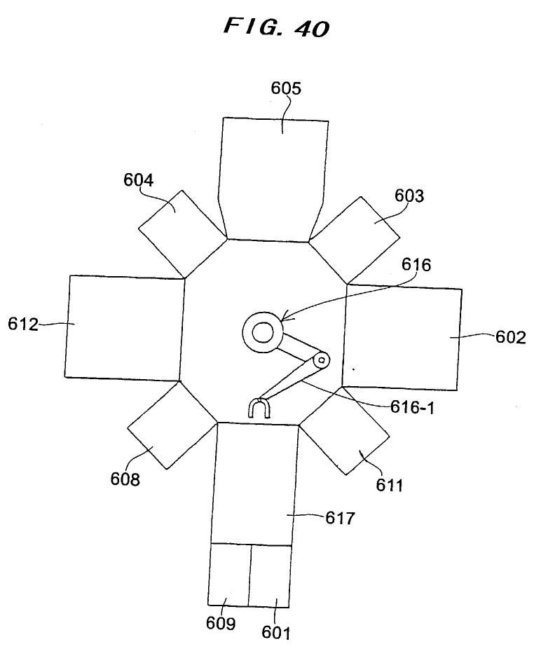

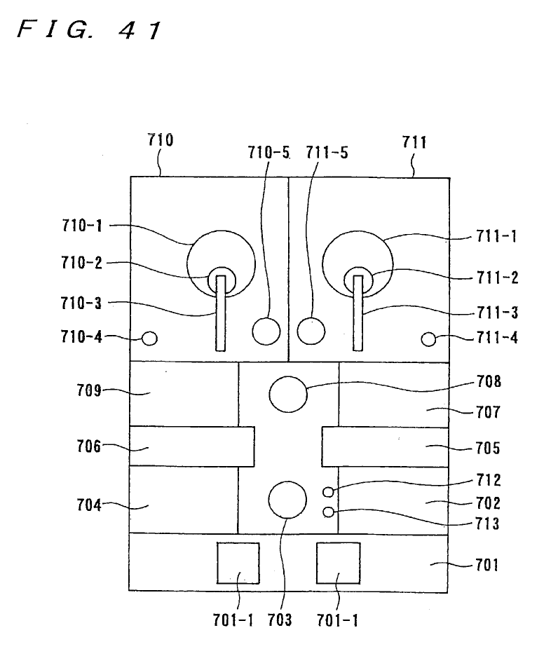

FIG. 40 is a plan view of still another example of a substrate processing apparatus for forming interconnects of the semiconductor substrate. As shown in FIG. 40, the substrate processing apparatus includes a robot 616 at its center, and also has a copper plating chamber 602, water cleaning chambers 603, 604, a CMP unit 605, a cap plating chamber 612, a drying chamber 608, and a loading/unloading unit 617 which are disposed around the robot 616 and positioned within the reach of the robot arm 616-1. The above equipments are combined into a single unitary arrangement as an apparatus. A loading unit 601 for loading semiconductor substrates and an unloading unit 609 for unloading semiconductor substrates are disposed adjacent to the loading/unloading unit 617.

The substrate processing apparatus described above operates as follows. A semiconductor substrate to be plated is transferred from the loading unit 601 to the loading/unloading unit 617, from which the semiconductor substrate is received by the robot arm 616-1 and transferred thereby to the copper plating chamber 602. In the copper plating chamber 602, a plated copper film is formed on a surface of the semiconductor substrate which has an interconnection region composed of an interconnection trench and an interconnection hole. The semiconductor substrate with the plated copper film formed thereon is transferred to the CMP unit 605 by the robot arm 616-1. In the CMP unit 605, the extra plated copper film is removed from the surface of the semiconductor substrate W, leaving a portion of the plated copper film in the interconnection trench and the interconnection hole.

The semiconductor substrate removed the extra plated copper film of the surface is then transferred by the robot arm 616-1 to the water-cleaning chamber 604, in which the semiconductor substrate is cleaned by water. Thereafter, the semiconductor substrate is transferred to the pretreatment chamber 611, in which the semiconductor substrate is pretreated for the cap plating. The pretreated semiconductor substrate is transferred to the cap plating chamber 612 by the robot arm 616-1. In the cap plating chamber 612, a protective plated layer is formed on the plated copper film in the interconnection region composed of an interconnection trench and an interconnection hole. The semiconductor substrate with the protective plated layer formed thereon is transferred by the robot arm 616-1 to the water cleaning chamber 604, in which the semiconductor substrate is cleaned by water. The cleaned semiconductor substrate is transferred to the drying chamber 608, in which the semiconductor substrate is dried. The dried semiconductor substrate is transferred to the loading/unloading unit 617, from which the plated semiconductor substrate is transferred to the unloading unit 609.

FIG. 41 is a view showing the plan constitution of another example of a semiconductor substrate processing apparatus. The semiconductor substrate processing apparatus is of a constitution in which there are provided a loading/unloading unit 701, a copper plating unit 702, a first robot 703, a third cleaning machine 704, a reversing machine 705, a reversing machine 706, a second cleaning machine 707, a second robot 708, a first cleaning machine 709, a first polishing apparatus 710, and a second polishing apparatus 711. A before-plating and after-plating film thickness measuring instrument 712 for measuring the film thicknesses before and after plating, and a dry state film thickness measuring instrument 713 for measuring the film thickness of a semiconductor substrate W in a dry state after polishing are placed near the first robot 703.

The first polishing apparatus (polishing unit) 710 has a polishing table 710-1, a top ring 710-2, a top ring head 710-3, a film thickness measuring instrument 710-4, and a pusher 710-5. The second polishing apparatus (polishing unit) 711 has a polishing table 711-1, a top ring 711-2, a top ring head 711-3, a film thickness measuring instrument 711-4, and a pusher 711-5.

A cassette 701-1 accommodating the semiconductor substrates W, in which contact holes and trenches for interconnect are formed, and a seed layer is formed thereon is placed on a loading port of the loading/unloading unit 701. The first robot 703 takes out the semiconductor substrate W from the cassette 701-1, and carries the semiconductor substrate W into the copper plating unit 702 where a plated copper film is formed. At this time, the film thickness of the seed layer is measured with the before-plating and after-plating film thickness measuring instrument 712. The plated copper film is formed by carrying out hydrophilic treatment of the face of the semiconductor substrate W, and then copper plating. After formation of the plated copper film, rinsing or cleaning of the semiconductor substrate W is carried out in the copper plating unit 702. The substrate may be dried in the extra time.

When the semiconductor substrate W is taken out from the copper plating unit 702 by the first robot 703, the film thickness of the plated copper film is measured with the before-plating and after-plating film thickness measuring instrument 712. The results of its measurement are recorded into a recording device (not shown) as record data on the semiconductor substrate, and are used for judgment of an abnormality of the copper plating unit 702. After measurement of the film thickness, the first robot 703 transfers the semiconductor substrate W to the reversing machine 705, and the reversing machine 705 reverses the semiconductor substrate W (the surface on which the plated copper film has been formed faces downward). The first polishing apparatus 710 and the second polishing apparatus 711 perform polishing in a serial mode and a parallel mode. Next, polishing in the serial mode will be described.

In the serial mode polishing, a primary polishing is performed by the polishing apparatus 710, and a secondary polishing is performed by the polishing apparatus 711. The second robot 708 picks up the semiconductor substrate W on the reversing machine 705, and places the semiconductor substrate W on the pusher 710-5 of the polishing apparatus 710. The top ring 710-2 attracts the semiconductor substrate W on the pusher 710-5 by suction, and brings the surface of the plated copper film of the semiconductor substrate W into contact with a polishing surface of the polishing table 710-1 under pressure to perform a primary polishing. With the primary polishing, the plated copper film is basically polished. The polishing surface of the polishing table 710-1 is composed of foamed polyurethane such as IC1000, or a material having abrasive grains fixed thereto or impregnated therein. Upon relative movements of the polishing surface and the semiconductor substrate W, the plated copper film is polished.

After completion of polishing of the plated copper film, the semiconductor substrate W is returned onto the pusher 710-5 by the top ring 710-2. The second robot 708 picks up the semiconductor substrate W, and introduces it into the first cleaning machine 709. At this time, a chemical liquid may be ejected toward the face and backside of the semiconductor substrate W on the pusher 710-5 to remove particles therefrom or cause particles to be difficult to adhere thereto.

After completion of cleaning in the first cleaning machine 709, the second robot 708 picks up the semiconductor substrate W, and places the semiconductor substrate W on the pusher 711-5 of the second polishing apparatus 711. The top ring 711-2 attracts the semiconductor substrate W on the pusher 711-5 by suction, and brings the surface of the semiconductor substrate W, which has the barrier layer formed thereon, into contact with a polishing surface of the polishing table 711-1 under pressure to perform the secondary polishing. With this secondary polishing, the barrier layer is polished. However, there may be a case in which a copper film and an oxide film left after the primary polishing are also polished.

A polishing surface of the polishing table 711-1 is composed of foamed polyurethane such as IC1000, or a material having abrasive grains fixed thereto or impregnated therein. Upon relative movements of the polishing surface and the semiconductor substrate W, polishing is carried out. At this time, silica, alumina, ceria, or the like is used as abrasive grains or slurry. A chemical liquid is adjusted depending on the type of the film to be polished.

Detection of an end point of the secondary polishing is performed by measuring the film thickness of the barrier layer mainly with the use of the optical film thickness measuring instrument, and detecting the film thickness which has become zero, or the surface of an insulating film comprising SiO₂ shows up. Furthermore, a film thickness measuring instrument with an image processing function is used as the film thickness measuring instrument 711-4 provided near the polishing table 711-1. By use of this measuring instrument, measurement of the oxide film is made, the results are stored as processing records of the semiconductor substrate W, and used for judging whether the semiconductor substrate W in which secondary polishing has been finished can be transferred to a subsequent step or not. If the endpoint of the secondary polishing is not reached, re-polishing is performed. If over-polishing has been performed beyond a prescribed value due to any abnormality, then the semiconductor substrate processing apparatus is stopped to avoid next polishing so that defective products will not increase.

After completion of the secondary polishing, the semiconductor substrate W is moved to the pusher 711-5 by the top ring 711-2. The second robot 708 picks up the semiconductor substrate W on the pusher 711-5. At this time, a chemical liquid may be ejected toward the face and backside of the semiconductor substrate W on the pusher 711-5 to remove particles therefrom or cause particles to be difficult to adhere thereto.

The second robot 708 carries the semiconductor substrate W into the second cleaning machine 707 where cleaning of the semiconductor substrate W is performed. The constitution of the second cleaning machine 707 is also the same as the constitution of the first cleaning machine 709. The surface of the semiconductor substrate W is scrubbed with the PVA sponge rolls using a cleaning liquid comprising pure water to which a surface active agent, a chelating agent, or a pH regulating agent is added. A strong chemical liquid such as DHF is ejected from a nozzle toward the backside of the semiconductor substrate W to perform etching of the diffused copper thereon. If there is no problem of diffusion, scrubbing cleaning is performed with the PVA sponge rolls using the same chemical liquid as that used for the surface.

After completion of the above cleaning, the second robot 708 picks up the semiconductor substrate W and transfers it to the reversing machine 706, and the reversing machine 706 reverses the semiconductor substrate W. The semiconductor substrate W which has been reversed is picked up by the first robot 703, and transferred to the third cleaning machine 704. In the third cleaning machine 704, megasonic water excited by ultrasonic vibrations is ejected toward the surface of the semiconductor substrate W to clean the semiconductor substrate W. At this time, the surface of the semiconductor substrate W may be cleaned with a known pencil type sponge using a cleaning liquid comprising pure water to which a surface active agent, a chelating agent, or a pH regulating agent is added. Thereafter, the semiconductor substrate W is dried by means of spin-drying.

As described above, if the film thickness has been measured with the film thickness measuring instrument 711-4 provided near the polishing table 711-1, then the semiconductor substrate W is accommodated into the cassette placed on the unloading port of the loading/unloading unit 701.

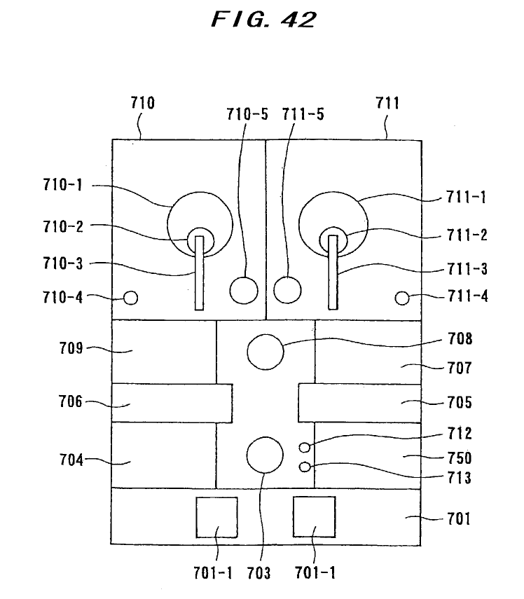

FIG. 42 is a view showing the plan constitution of another example of a semiconductor substrate processing apparatus. The semiconductor substrate processing apparatus differs from the semiconductor substrate processing apparatus shown in FIG. 41 in that a cap plating unit 750 is provided instead of the copper plating unit 702 in FIG. 41.

A cassette 701-1 accommodating the semiconductor substrates W on which a copper film is formed is placed on a loading/unloading unit 701. The semiconductor substrate W taken out from the cassette 701-1 is transferred to the first polishing apparatus 710 or second polishing apparatus 711 in which the surface of the copper film is polished. After completion of polishing of the copper film, the semiconductor substrate W is transferred and cleaned in the first cleaning machine 709.

After completion of cleaning in the first cleaning machine 709, the semiconductor substrate W is transferred to the cap plating unit 750 where a protective plated layer is formed on the surface of the plated copper film with the aim of preventing oxidation of plated copper film due to the atmosphere. The semiconductor substrate to which cap plating has been applied is carried by the second robot 708 from the cap plating unit 750 to the second cleaning machine 707 where it is cleaned with pure water or deionized water. The semiconductor substrate W after completion of cleaning is returned into the cassette 701-1 placed on the loading/unloading unit 701.

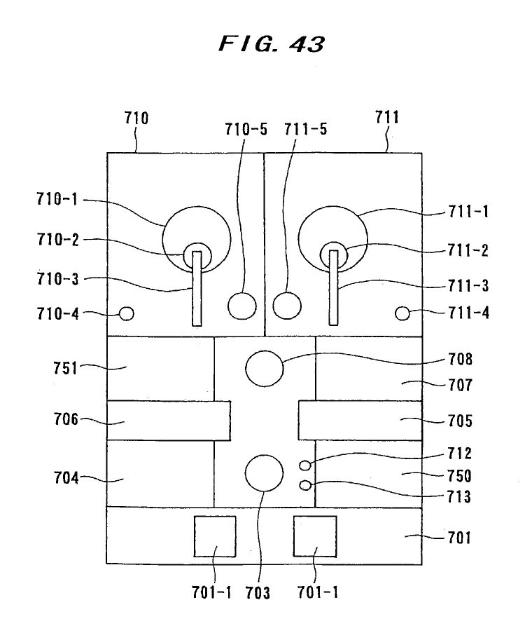

FIG. 43 is a view showing the plan constitution of still another example of a semiconductor substrate processing apparatus. The substrate processing apparatus differs from the substrate processing apparatus shown in FIG. 42 in that an annealing unit 751 is provided instead of the first cleaning machine 709 in FIG. 42.

The semiconductor substrate W, which is polished in the first polishing unit 710 or second polishing unit 711, and cleaned in the second cleaning machine 707 described above, is transferred to the cap plating unit 750 where cap plating is applied onto the surface of the plated copper film. The semiconductor substrate W to which cap plating has been applied is carried by the first robot 703 from the cap plating unit 750 to the third cleaning machine 704 where it is cleaned.

After completion of cleaning in the first cleaning machine 709, the semiconductor substrate W is transferred to the annealing unit 751 in which the substrate W is annealed, whereby the plated copper film is alloyed so as to increase the electromigration resistance of the plated copper film. The semiconductor substrate W to which annealing treatment has been applied is carried from the annealing unit 751 to the second cleaning machine 707 where it is cleaned with pure water or deionized water. The semiconductor substrate W after completion of cleaning is returned into the cassette 701-1 placed on the loading/unloading unit 701.

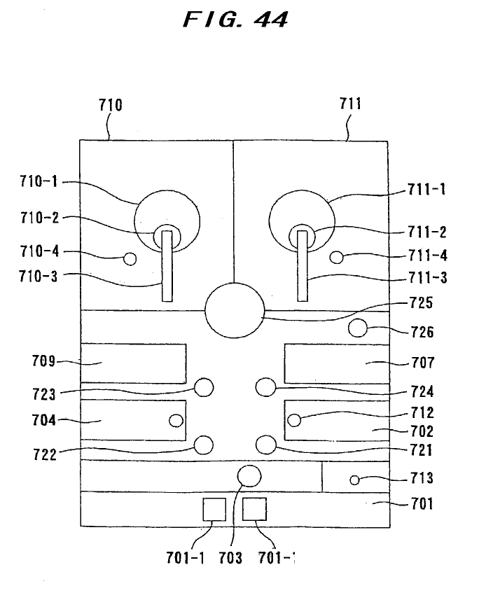

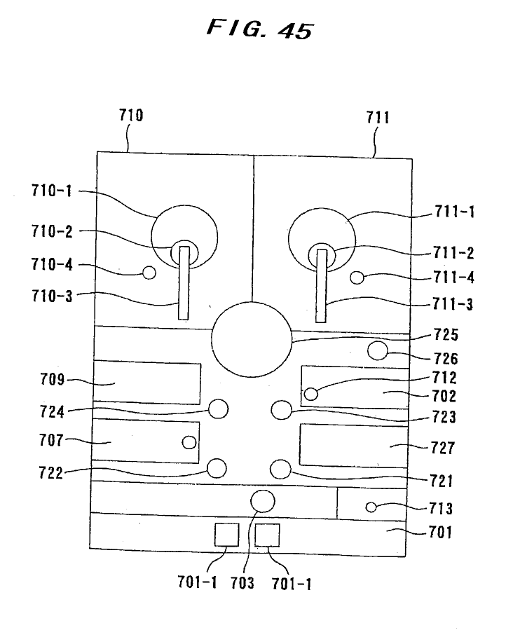

FIG. 44 is a view showing a plan layout constitution of another example of the substrate processing apparatus. In FIG. 44, portions denoted by the same reference numerals as those in FIG. 41 show the same or corresponding portions. In the substrate processing apparatus, a pusher indexer 725 is disposed close to a first polishing apparatus 710 and a second polishing apparatus 711. Substrate placing tables 721, 722 are disposed close to a third cleaning machine 704 and a copper plating unit 702, respectively. A robot 723 is disposed close to a first cleaning machine 709 and the third cleaning machine 704. Further, a robot 724 is disposed close to a second cleaning machine 707 and the copper plating unit 702, and a dry state film thickness measuring instrument 713 is disposed close to a loading/unloading unit 701 and a first robot 703.

In the substrate processing apparatus of the above constitution, the first robot 703 takes out a semiconductor substrate W from a cassette 701-1 placed on the load port of the loading/unloading unit 701. After the film thicknesses of a barrier layer and a seed layer are measured with the dry state film thickness measuring instrument 713, the first robot 703 places the semiconductor substrate W on the substrate placing table 721. In the case where the dry state film thickness measuring instrument 713 is provided on the hand of the first robot 703, the film thicknesses are measured thereon, and the substrate is placed on the substrate placing table 721. The second robot 723 transfers the semiconductor substrate W on the substrate placing table 721 to the copper plating unit 702 in which a plated copper film is formed. After formation of the plated copper film, the film thickness of the plated copper film is measured with a before-plating and after-plating film thickness measuring instrument 712. Then, the second robot 723 transfers the semiconductor substrate W to the pusher indexer 725 and loads it thereon.

[Serial Mode]

In the serial mode, a top ring 710-2 holds the semiconductor substrate W on the pusher indexer 725 by suction, transfers it to a polishing table 710-1, and presses the semiconductor substrate W against a polishing surface on the polishing table 710-1 to perform polishing. Detection of the end point of polishing is performed by the same method as described above. The semiconductor substrate W after completion of polishing is transferred to the pusher indexer 725 by the top ring 710-2, and loaded thereon. The second robot 723 takes out the semiconductor substrate W, and carries it into the first cleaning machine 709 for cleaning. Then, the semiconductor substrate W is transferred to the pusher indexer 725, and loaded thereon.

A top ring 711-2 holds the semiconductor substrate W on the pusher indexer 725 by suction, transfers it to a polishing table 711-1, and presses the semiconductor substrate W against a polishing surface on the polishing table 711-1 to perform polishing. Detection of the end point of polishing is performed by the same method as described above. The semiconductor substrate W after completion of polishing is transferred to the pusher indexer 725 by the top ring 711-2, and loaded thereon. The third robot 724 picks up the semiconductor substrate W, and its film thickness is measured with a film thickness measuring instrument 726. Then, the semiconductor substrate W is carried into the second cleaning machine 707 for cleaning. Thereafter, the semiconductor substrate W is carried into the third cleaning machine 704, where it is cleaned and then dried by spin-drying. Then, the semiconductor substrate W is picked up by the third robot 724, and placed on the substrate placing table 722.

[Parallel Mode]

In the parallel mode, the top ring 710-2 or 711-2 holds the semiconductor substrate Won the pusher indexer 725 by suction, transfers it to the polishing table 710-1 or 711-1, and presses the semiconductor substrate W against the polishing surface on the polishing table 710-1 or 711-1 to perform polishing. After measurement of the film thickness, the third robot 724 picks up the semiconductor substrate W, and places it on the substrate placing table 722.

The first robot 703 transfers the semiconductor substrate W on the substrate placing table 722 to the dry state film thickness measuring instrument 713. After the film thickness is measured, the semiconductor substrate W is returned to the cassette 701-1 of the loading/unloading unit 701.

FIG. 45 is a view showing another plan layout constitution of the substrate processing apparatus. The substrate processing apparatus is such a substrate processing apparatus which forms a seed layer and a plated copper film on a semiconductor substrate W having no seed layer formed thereon, and polishes these films to form interconnections.

In the substrate polishing apparatus, a pusher indexer 725 is disposed close to a first polishing apparatus 710 and a second polishing apparatus 711, substrate placing tables 721, 722 are disposed close to a second cleaning machine 707 and a seed layer forming unit 727, respectively, and a robot 723 is disposed close to the seed layer forming unit 727 and a copper plating unit 702. Further, a robot 724 is disposed close to a first cleaning machine 709 and the second cleaning machine 707, and a dry state film thickness measuring instrument 713 is disposed close to a loading/unloading unit 701 and a first robot 703.

The first robot 703 takes out a semiconductor substrate W having a barrier layer thereon from a cassette 701-1 placed on the load port of the loading/unloading unit 701, and places it on the substrate placing table 721. Then, the second robot 723 transfers the semiconductor substrate W to the seed layer forming unit 727 where a seed layer is formed. The seed layer is formed by means of electroless plating. The second robot 723 enables the semiconductor substrate having the seed layer formed thereon to be measured in thickness of the seed layer by the before-plating and after-plating film thickness measuring instrument 712. After measurement of the film thickness, the semiconductor substrate is carried into the copper plating unit 702 where a plated copper film is formed.

After formation of the plated copper film, its film thickness is measured, and the semiconductor substrate is transferred to a pusher indexer 725. A top ring 710-2 or 711-2 holds the semiconductor substrate W on the pusher indexer 725 by suction, and transfers it to a polishing table 710-1 or 711-1 to perform polishing. After polishing, the top ring 710-2 or 711-2 transfers the semiconductor substrate W to a film thickness measuring instrument 710-4 or 711-4 to measure the film thickness, and then transfers the semiconductor substrate W to the pusher indexer 725, and places it thereon.

Then, the third robot 724 picks up the semiconductor substrate W from the pusher indexer 725, and carries it into the first cleaning machine 709. The third robot 724 picks up the cleaned semiconductor substrate W from the first cleaning machine 709, carries it into the second cleaning machine 707, and places the cleaned and dried semiconductor substrate on the substrate placing table 722. Then, the first robot 703 picks up the semiconductor substrate W, and transfers it to the dry state film thickness measuring instrument 713 in which the film thickness is measured, and the first robot 703 carries it into the cassette 701-1 placed on the unload port of the loading/unloading unit 701.

In the substrate processing apparatus shown in FIG. 45, interconnections are formed by forming a barrier layer, a seed layer and a plated copper film on a semiconductor substrate W having contact holes or trenches of a circuit pattern formed therein, and polishing them.

The cassette 701-1 accommodating the semiconductor substrates W before formation of the barrier layer is placed on the load port of the loading/unloading unit 701. The first robot 703 takes out the semiconductor substrate W from the cassette 701-1 placed on the load port of the loading/unloading unit 701, and places it on the substrate placing table 721. Then, the second robot 723 transfers the semiconductor substrate W to the seed layer forming unit 727 where a barrier layer and a seed layer are formed. The barrier layer and the seed layer are formed by electroless plating. The second robot 723 brings the semiconductor substrate W having the barrier layer and the seed layer formed thereon to the before-plating and after-plating film thickness measuring instrument 712 which measures the film thicknesses of the barrier layer and the seed layer. After measurement of the film thicknesses, the semiconductor substrate W is carried into the copper plating unit 702 where a plated copper film is formed.

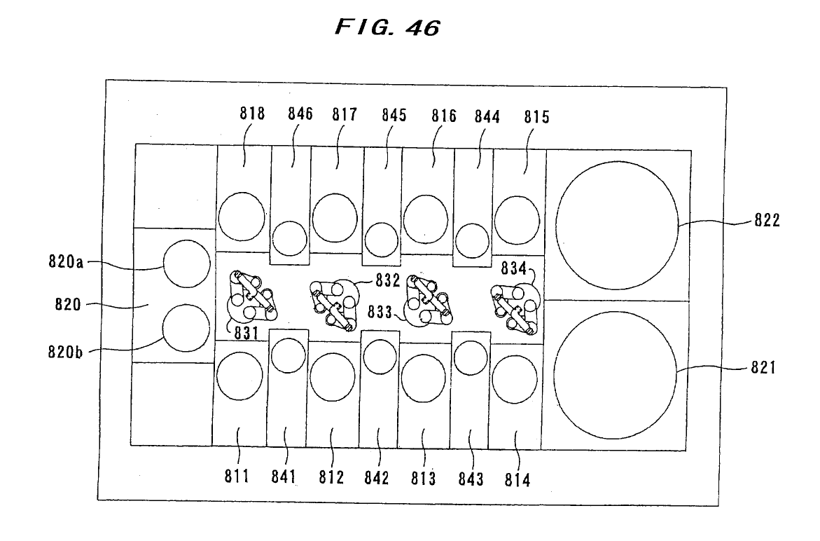

FIG. 46 is a view showing plan layout constitution of another example of the substrate processing apparatus. In the substrate processing apparatus, there are provided a barrier layer forming unit 811, a seed layer forming unit 812, a plating unit 813, an annealing unit 814, a first cleaning unit 815, a bevel and backside cleaning unit 816, a cap plating unit 817, a second cleaning unit 818, a first aligner and film thickness measuring instrument 841, a second aligner and film thickness measuring instrument 842, a first substrate reversing machine 843, a second substrate reversing machine 844, a substrate temporary placing table 845, a third film thickness measuring instrument 846, a loading/unloading unit 820, a first polishing apparatus 821, a second polishing apparatus 822, a first robot 831, a second robot 832, a third robot 833, and a fourth robot 834. The film thickness measuring instruments 841, 842, and 846 are units, have the same size as the frontage dimension of other units (plating, cleaning, annealing units, and the like), and are thus interchangeable.

In this example, an electroless Ru plating apparatus can be used as the barrier layer forming unit 811, an electroless copper plating apparatus as the seed layer forming unit 812, and an electroplating apparatus as the plating unit 813.

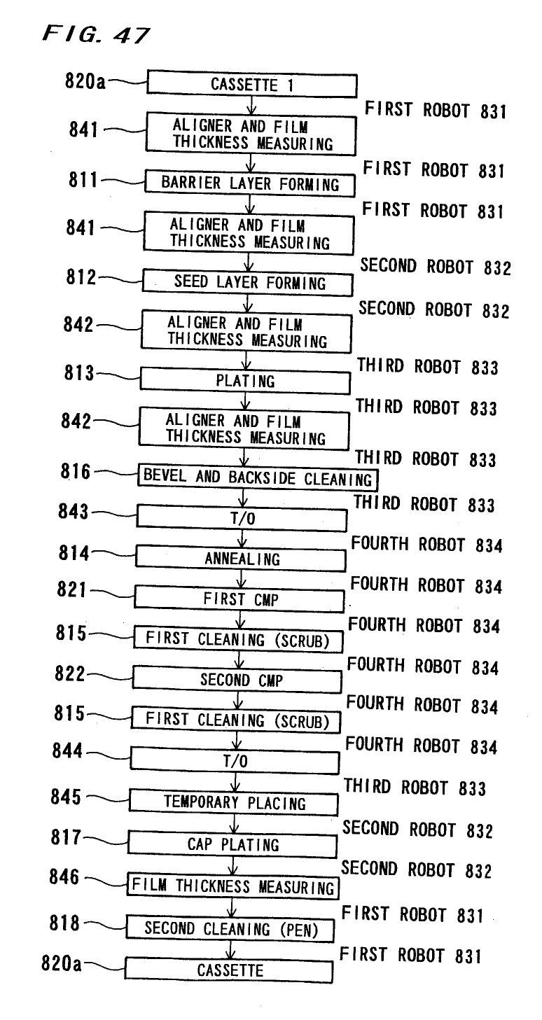

FIG. 47 is a flow chart showing the flow of the respective steps in the present substrate processing apparatus. The respective steps in the apparatus will be described according to this flow chart. First, a semiconductor substrate taken out by the first robot 831 from a cassette 820a placed on the load and unload unit 820 is placed in the first aligner and film thickness measuring instrument 841, in such a state that its surface, to be plated, faces upward. In order to set a reference point for a position at which film thickness measurement is made, notch alignment for film thickness measurement is performed, and then film thickness data on the semiconductor substrate before formation of a copper film are obtained.

Then, the semiconductor substrate is transferred to the barrier layer forming unit 811 by the first robot 831. The barrier layer forming unit 811 is such an apparatus for forming a barrier layer on the semiconductor substrate by electroless Co—W plating, and the barrier layer forming unit 811 forms a Co—W film as a film for preventing copper from diffusing into an interlevel dielectric (e.g. SiO₂) of a semiconductor device. The semiconductor substrate discharged after cleaning and drying steps is transferred by the first robot 831 to the first aligner and film thickness measuring instrument 841, where the film thickness of the semiconductor substrate, i.e., the film thickness of the barrier layer is measured.

The semiconductor substrate after film thickness measurement is carried into the seed layer forming unit 812 by the second robot 832, and a seed layer is formed on the barrier layer by electroless copper plating. The semiconductor substrate discharged after cleaning and drying steps is transferred by the second robot 832 to the second aligner and film thickness measuring instrument 842 for determination of a notch position, before the semiconductor substrate is transferred to the plating unit 813, which is an impregnation plating unit, and then notch alignment for copper plating is performed by the film thickness measuring instrument 842. If necessary, the film thickness of the semiconductor substrate before formation of a copper film may be measured again in the film thickness measuring instrument 842.

The semiconductor substrate which has completed notch alignment is transferred by the third robot 833 to the plating unit 813 where copper plating is applied to the semiconductor substrate. The semiconductor substrate discharged after cleaning and drying steps is transferred by the third robot 833 to the bevel and backside cleaning unit 816 where an unnecessary copper film (seed layer) at a peripheral portion of the semiconductor substrate is removed. In the bevel and backside cleaning unit 816, the bevel is etched in a preset time, and copper adhering to the backside of the semiconductor substrate is cleaned with a chemical liquid such as hydrofluoric acid. At this time, before transferring the semiconductor substrate to the bevel and backside cleaning unit 816, film thickness measurement of the semiconductor substrate may be made by the second aligner and film thickness measuring instrument 842 to obtain the thickness value of the copper film formed by plating, and based on the obtained results, the bevel etching time may be changed arbitrarily to carry out etching. The region etched away by bevel etching is a region which corresponds to a peripheral edge portion of the substrate and has no circuit formed therein, or a region which is not utilized finally as a chip although a circuit is formed. A bevel portion is included in this region.

The semiconductor substrate discharged after cleaning and drying steps in the bevel and backside cleaning unit 816 is transferred by the third robot 833 to the substrate reversing machine 843. After the semiconductor substrate is turned over by the substrate reversing machine 843 to cause the plated surface to be directed downward, the semiconductor substrate is introduced into the annealing unit 814 by the fourth robot 834 for thereby stabilizing an interconnection portion. Before and/or after annealing treatment, the semiconductor substrate is carried into the second aligner and film thickness measuring instrument 842 where the film thickness of a copper film formed on the semiconductor substrate is measured. Then, the semiconductor substrate is carried by the fourth robot 834 into the first polishing apparatus 821 in which the copper film and the seed layer of the semiconductor substrate are polished.

At this time, desired abrasive grains or the like are used, but fixed abrasive may be used in order to prevent dishing and enhance flatness of the face. After completion of primary polishing, the semiconductor substrate is transferred by the fourth robot 834 to the first cleaning unit 815 where it is cleaned. This cleaning is scrub-cleaning in which rolls having substantially the same length as the diameter of the semiconductor substrate are placed on the face and the backside of the semiconductor substrate, and the semiconductor substrate and the rolls are rotated, while pure water or deionized water is flowed, thereby performing cleaning of the semiconductor substrate.

After completion of the primary cleaning, the semiconductor substrate is transferred by the fourth robot 834 to the second polishing apparatus 822 where the barrier layer on the semiconductor substrate is polished. At this time, desired abrasive grains or the like are used, but fixed abrasive may be used in order to prevent dishing and enhance flatness of the face. After completion of secondary polishing, the semiconductor substrate is transferred by the fourth robot 834 again to the first cleaning unit 815 where scrub-cleaning is performed. After completion of cleaning, the semiconductor substrate is transferred by the fourth robot 834 to the second substrate reversing machine 844 where the semiconductor substrate is reversed to cause the plated surface to be directed upward, and then the semiconductor substrate is placed on the substrate temporary placing table 845 by the third robot 833.

The semiconductor substrate is transferred by the second robot 832 from the substrate temporary placing table 845 to the cap plating unit 817 where Ni—B plating is applied onto the copper surface with the aim of preventing oxidation of copper due to the atmosphere. The semiconductor substrate to which cap plating has been applied is carried by the second robot 832 from the cap plating unit 817 to the third film thickness measuring instrument 846 where the thickness of the copper film is measured. Thereafter, the semiconductor substrate is carried by the first robot 831 into the second cleaning unit 818 where it is cleaned with pure water or deionized water. The semiconductor substrate after completion of cleaning is returned into the cassette 820a placed on the loading/unloading unit 820.

The aligner and film thickness measuring instrument 841 and the aligner and film thickness measuring instrument 842 perform positioning of the notch portion of the substrate and measurement of the film thickness.

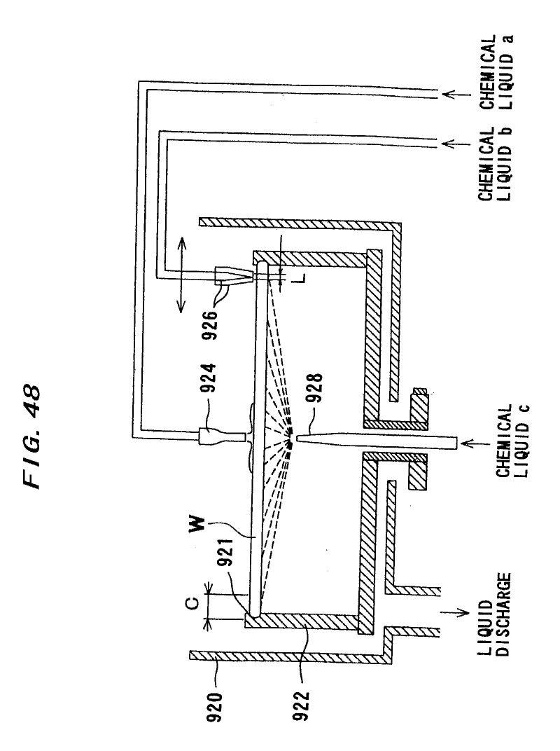

The bevel and backside cleaning unit 816 can perform an edge (bevel) copper etching and a backside cleaning at the same time, and can suppress growth of a natural oxide film of copper at the circuit formation portion on the surface of the substrate. FIG. 48 shows a schematic view of the bevel and backside cleaning unit 816. As shown in FIG. 48, the bevel and backside cleaning unit 816 has a substrate holding portion 922 positioned inside a bottomed cylindrical waterproof cover 920 and adapted to rotate a substrate W at a high speed, in such a state that the face of the substrate W faces upward, while holding the substrate W horizontally by spin chucks 921 at a plurality of locations along a circumferential direction of a peripheral edge portion of the substrate, a center nozzle 924 placed above a nearly central portion of the face of the substrate W held by the substrate holding portion 922, and an edge nozzle 926 placed above the peripheral edge portion of the substrate W. The center nozzle 924 and the edge nozzle 926 are directed downward. A back nozzle 928 is positioned below a nearly central portion of the backside of the substrate W, and directed upward. The edge nozzle 926 is adapted to be movable in a diametrical direction and a height direction of the substrate W.

The width of movement L of the edge nozzle 926 is set such that the edge nozzle 926 can be arbitrarily positioned in a direction toward the center from the outer peripheral end surface of the substrate, and a set value for L is inputted according to the size, usage, or the like of the substrate W. Normally, an edge cut width C is set in the range of 2 mm to 5 mm. In the case where a rotational speed of the substrate is a certain value or higher at which the amount of liquid migration from the backside to the face is not problematic, the copper film within the edge cut width C can be removed.

Next, the method of cleaning with this cleaning apparatus will be described. First, the semiconductor substrate W is horizontally rotated integrally with the substrate holding portion 922, with the substrate being held horizontally by the spin chucks 921 of the substrate holding portion 922. In this state, an acid solution is supplied from the center nozzle 924 to the central portion of the face of the substrate W. The acid solution may be a non-oxidizing acid, and hydrofluoric acid, hydrochloric acid, sulfuric acid, citric acid, oxalic acid, or the like is used. On the other hand, an oxidizing agent solution is supplied continuously or intermittently from the edge nozzle 926 to the peripheral edge portion of the substrate W. As the oxidizing agent solution, one of an aqueous solution of ozone, an aqueous solution of hydrogen peroxide, an aqueous solution of nitric acid, and an aqueous solution of sodium hypochlorite is used, or a combination of these is used.

In this manner, the copper film, or the like formed on the upper surface and end surface in the region of the edge cut width C of the semiconductor substrate W is rapidly oxidized with the oxidizing agent solution, and is simultaneously etched with the acid solution supplied from the center nozzle 924 and spread on the entire face of the substrate, whereby it is dissolved and removed. By mixing the acid solution and the oxidizing agent solution at the peripheral edge portion of the substrate, a steep etching profile can be obtained, in comparison with a mixture of them which is produced in advance being supplied. At this time, the copper etching rate is determined by their concentrations. If a natural oxide film of copper is formed in the circuit-formed portion on the face of the substrate, this natural oxide is immediately removed by the acid solution spreading on the entire face of the substrate according to rotation of the substrate, and does not grow any more. After the supply of the acid solution from the center nozzle 924 is stopped, the supply of the oxidizing agent solution from the edge nozzle 926 is stopped. As a result, silicon exposed on the surface is oxidized, and deposition of copper can be suppressed.

On the other hand, an oxidizing agent solution and a silicon oxide film etching agent are supplied simultaneously or alternately from the back nozzle 928 to the central portion of the backside of the substrate. Therefore, copper or the like adhering in a metal form to the backside of the semiconductor substrate W can be oxidized with the oxidizing agent solution, together with silicon of the substrate, and can be etched and removed with the silicon oxide film etching agent. This oxidizing agent solution is preferably the same as the oxidizing agent solution supplied to the face, because the types of chemicals are decreased in number. Hydrofluoric acid can be used as the silicon oxide film etching agent, and if hydrofluoric acid is used as the acid solution on the face of the substrate, the types of chemicals can be decreased in number. Thus, if the supply of the oxidizing agent is stopped first, a hydrophobic surface is obtained. If the etching agent solution is stopped first, a water-saturated surface (a hydrophilic surface) is obtained, and thus the backside surface can be adjusted to a condition that will satisfy the requirements of a subsequent process.

In this manner, the acid solution, i.e., etching solution is supplied to the substrate to remove metal ions remaining on the surface of the substrate W. Then, pure water is supplied to replace the etching solution with pure water and remove the etching solution, and then the substrate is dried by spin-drying. In this way, removal of the copper film in the edge cut width C at the peripheral edge portion on the face of the semiconductor substrate, and removal of copper contaminants on the backside are performed simultaneously to thus allow this treatment to be completed, for example, within 80 seconds. The etching cut width of the edge can be set arbitrarily (from 2 to 5 mm), but the time required for etching does not depend on the cut width.

Annealing treatment performed before the CMP process and after plating has a favorable effect on the subsequent CMP treatment and on the electrical characteristics of interconnection. Observation of the surface of broad interconnection (unit of several micrometers) after the CMP treatment without annealing showed many defects such as microvoids, which resulted in an increase in the electrical resistance of the entire interconnection. Execution of annealing ameliorated the increase in the electrical resistance. In the presence of annealing, thin interconnection showed no voids. Thus, the degree of grain growth is presumed to be involved in these phenomena. That is, the following mechanism can be speculated: Grain growth is difficult to occur in thin interconnection. In broad interconnection, on the other hand, grain growth proceeds in accordance with annealing treatment. During the process of grain growth, ultra-fine pores in the plated film, which are too small to be seen by the SEM (scanning electron microscope), gather and move upward, thus forming microvoid-like depressions in the upper part of the interconnection. The annealing conditions in the annealing unit are such that hydrogen (2% or less) is added in a gas atmosphere, the temperature is in the range of 300° C. to 400° C., and the time is in the range of 1 to 5 minutes. Under these conditions, the above effects were obtained.

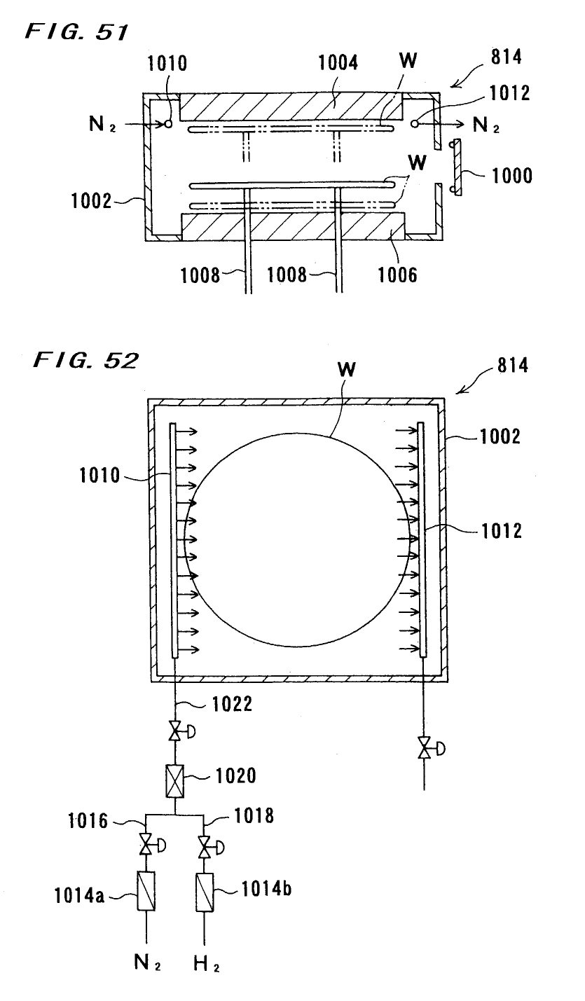

FIGS. 51 and 52 show the annealing unit 814. The annealing unit 814 comprises a chamber 1002 having a gate 1000 for taking in and taking out the semiconductor substrate W, a hot plate 1004 disposed at an upper position in the chamber 1002 for heating the semiconductor substrate W to e.g. 400° C., and a cool plate 1006 disposed at a lower position in the chamber 1002 for cooling the semiconductor substrate W by, for example, flowing cooling water inside the plate. The annealing unit 814 also has a plurality of vertically movable elevating pins 1008 penetrating the cool plate 1006 and extending upward and downward therethrough for placing and holding the semiconductor substrate W on them. The annealing unit further includes a gas introduction pipe 1010 for introducing an antioxidant gas between the semiconductor substrate W and the hot plate 1004 during annealing, and a gas discharge pipe 1012 for discharging the gas which has been introduced from the gas introduction pipe 1010 and flowed between the semiconductor substrate W and the hot plate 1004. The pipes 1010 and 1012 are disposed on the opposite sides of the hot plate 1004.

The gas introduction pipe 1010 is connected to a mixed gas introduction line 1022 which in turn is connected to a mixer 1020 where a N₂ gas introduced through a N₂ gas introduction line 1016 containing a filter 1014a, and a H₂ gas introduced through a H₂ gas introduction line 1018 containing a filter 1014b, are mixed to form a mixed gas which flows through the line 1022 into the gas introduction pipe 1010.

In operation, the semiconductor substrate W, which has been carried in the chamber 1002 through the gate 1000, is held on the elevating pins 1008 and the elevating pins 1008 are raised up to a position at which the distance between the semiconductor substrate W held on the lifting pins 1008 and the hot plate 1004 becomes e.g. 0.1-1.0 mm. In this state, the semiconductor substrate W is then heated to e.g. 400° C. through the hot plate 1004 and, at the same time, the antioxidant gas is introduced from the gas introduction pipe 1010 and the gas is allowed to flow between the semiconductor substrate W and the hot plate 1004 while the gas is discharged from the gas discharge pipe 1012, thereby annealing the semiconductor substrate W while preventing its oxidation. The annealing treatment may be completed in about several tens of seconds to 60 seconds. The heating temperature of the substrate may be selected in the range of 100-600° C.

After the completion of the annealing, the elevating pins 1008 are lowered down to a position at which the distance between the semiconductor substrate W held on the elevating pins 1008 and the cool plate 1006 becomes e.g. 0-0.5 mm. In this state, by introducing cooling water into the cool plate 1006, the semiconductor substrate W is cooled by the cool plate to a temperature of 100° C. or lower in e.g. 10-60 seconds. The cooled semiconductor substrate is sent to the next step.

A mixed gas of N₂ gas with several percentages of H₂ gas is used as the above antioxidant gas. However, N₂ gas may be used singly.

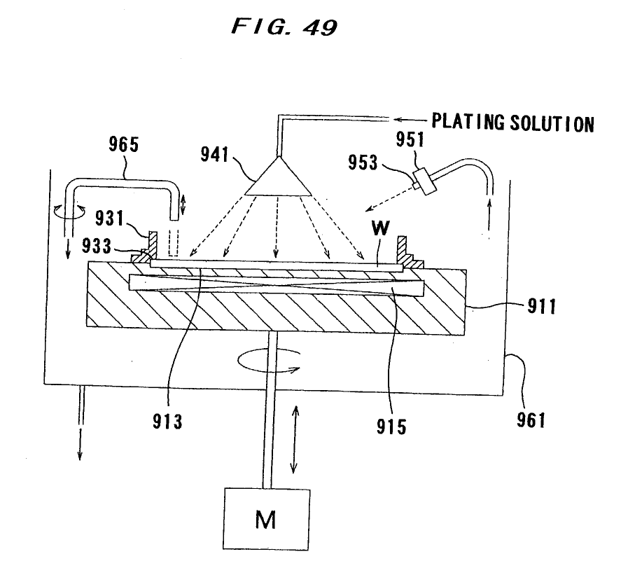

FIG. 49 is a schematic constitution drawing of the electroless plating apparatus. As shown in FIG. 49, this electroless plating apparatus comprises holding means 911 for holding a semiconductor substrate W to be plated on its upper surface, a dam member 931 for contacting a peripheral edge portion of a surface to be plated (upper surface) of the semiconductor substrate W held by the holding means 911 to seal the peripheral edge portion, and a shower head 941 for supplying a plating solution to the surface, to be plated, of the semiconductor substrate W having the peripheral edge portion sealed with the dam member 931. The electroless plating apparatus further comprises cleaning liquid supply means 951 disposed near an upper outer periphery of the holding means 911 for supplying a cleaning liquid to the surface, to be plated, of the semiconductor substrate W, a recovery vessel 961 for recovering a cleaning liquid or the like (plating waste liquid) discharged, a plating solution recovery nozzle 965 for sucking in and recovering the plating solution held on the semiconductor substrate W, and a motor M for rotationally driving the holding means 911. The respective members will be described below.

The holding means 911 has a substrate placing portion 913 on its upper surface for placing and holding the semiconductor substrate W. The substrate placing portion 913 is adapted to place and fix the semiconductor substrate W. Specifically, the substrate placing portion 913 has a vacuum attracting mechanism (not shown) for attracting the semiconductor substrate W to a backside thereof by vacuum suction. A backside heater 915, which is planar and heats the surface, to be plated, of the semiconductor substrate W from underside to keep it warm, is installed on the backside of the substrate placing portion 913. The backside heater 915 is composed of, for example, a rubber heater. This holding means 911 is adapted to be rotated by the motor M and is movable vertically by raising and lowering means (not shown).

The dam member 931 is tubular, has a seal portion 933 provided in a lower portion thereof for sealing the outer peripheral edge of the semiconductor substrate W, and is installed so as not to move vertically from the illustrated position.

The shower head 941 is of a structure having many nozzles provided at the front end for scattering the supplied plating solution in a shower form and supplying it substantially uniformly to the surface, to be plated, of the semiconductor substrate W. The cleaning liquid supply means 951 has a structure for ejecting a cleaning liquid from a nozzle 953.

The plating solution recovery nozzle 965 is adapted to be movable upward and downward and swingable, and the front end of the plating solution recovery nozzle 965 is adapted to be lowered inwardly of the dam member 931 located on the upper surface peripheral edge portion of the semiconductor substrate W and to suck in the plating solution on the semiconductor substrate W.

Next, the operation of the electroless plating apparatus will be described. First, the holding means 911 is lowered from the illustrated state to provide a gap of a predetermined dimension between the holding means 911 and the dam member 931, and the semiconductor substrate W is placed on and fixed to the substrate placing portion 913. An 8 inch substrate, for example, is used as the semiconductor substrate W.

Then, the holding means 911 is raised to bring its upper surface into contact with the lower surface of the dam member 931 as illustrated, and at the same time periphery of the semiconductor substrate W is sealed with the seal portion 933 of the dam member 931. At this time, the surface of the semiconductor substrate W is in an open state.

Then, the semiconductor substrate W itself is directly heated by the backside heater 915 to render the temperature of the semiconductor substrate W, for example, 70° C. (maintained until termination of plating). Then, the plating solution heated, for example, to 50° C. is ejected from the shower head 941 to pour the plating solution over substantially the entire surface of the semiconductor substrate W. Since the surface of the semiconductor substrate W is surrounded by the dame member 931, the poured plating solution is all held on the surface of the semiconductor substrate W. The amount of the supplied plating solution may be a small amount which will become a 1 mm thickness (about 30 ml) on the surface of the semiconductor substrate W. The depth of the plating solution held on the surface to be plated may be 10 mm or less, and may be even 1 mm as in this embodiment. If a small amount of the supplied plating solution is sufficient, the heating apparatus for heating the plating solution may be of a small size. In this example, the temperature of the semiconductor substrate W is raised to 70° C., and the temperature of the plating solution is raised to 50° C. by heating. Thus, the surface, to be plated, of the semiconductor substrate W becomes, for example, 60° C., and hence a temperature optimal for a plating reaction in this example can be achieved. In this manner, since the semiconductor substrate W itself is heated, it is not necessary to heat the plating solution, which would consume much electric power to be heated, to a high temperature. Therefore, electric power to be consumed can be reduced, and the plating solution can be prevented from changing in materials contained therein. The electric power required for heating the semiconductor substrate W itself and the amount of the plating solution held on the semiconductor substrate W are so small that the semiconductor substrate W can easily be kept warm by the backside heater 915. Therefore, a heater having a small thermal capacity can be used as the backside heater 915, and hence the apparatus can be made compact in size. When the semiconductor substrate W itself is cooled by a cooling mechanism, the plating conditions can be changed during the plating process by switching heating and cooling. Since the amount of the plating solution held on the semiconductor substrate is small, the temperature can be controlled with high sensitivity.

The semiconductor substrate W is instantaneously rotated by the motor M to perform uniform liquid wetting of the surface to be plated, and then plating of the surface to be plated is performed in such a state that the semiconductor substrate W is in a stationary state. Specifically, the semiconductor substrate W is rotated at 100 rpm or less for only 1 second to uniformly wet the surface, to be plated, of the semiconductor substrate W with the plating solution. Then, the semiconductor substrate W is kept stationary, and electroless plating is performed for 1 minute. The instantaneous rotating time is 10 seconds or less at the longest.

After completion of the plating treatment, the front end of the plating solution recovery nozzle 965 is lowered to an area near the inside of the dam member 931 on the peripheral edge portion of the semiconductor substrate W to suck in the plating solution. At this time, if the semiconductor substrate W is rotated at a rotational speed of, for example, 100 rpm or less, the plating solution remaining on the semiconductor substrate W can be gathered in the portion of the dam member 931 on the peripheral edge portion of the semiconductor substrate W under centrifugal force, so that recovery of the plating solution can be performed with a good efficiency and a high recovery rate. The holding means 911 is lowered to separate the semiconductor substrate W from the dam member 931. The semiconductor substrate W is started to be rotated, and the cleaning liquid (ultra-pure water) is jetted at the plated surface of the semiconductor substrate W from the nozzle 953 of the cleaning liquid supply means 951 to cool the plated surface, and simultaneously perform dilution and cleaning, thereby stopping the electroless plating reaction. At this time, the cleaning liquid jetted from the nozzle 953 may be supplied to the dam member 931 to perform cleaning of the dam member 931 at the same time. The plating waste liquid at this time is recovered into the recovery vessel 961 and discarded.

The plating solution used once is not reused, but discarded. Since the plating apparatus can use an extremely smaller amount of the plating solution than a conventional plating apparatus, as described above, even if the plating solution is not reused, the amount of the plating solution to be discarded is small. In some cases, the plating solution recovery nozzle 965 may not be provided, and the used plating solution may be recovered into the recovery vessel 961 together with the cleaning liquid.

Then, the semiconductor substrate W is rotated at a high speed by the motor M for spin-drying, and then the semiconductor substrate W is removed from the holding means 911.

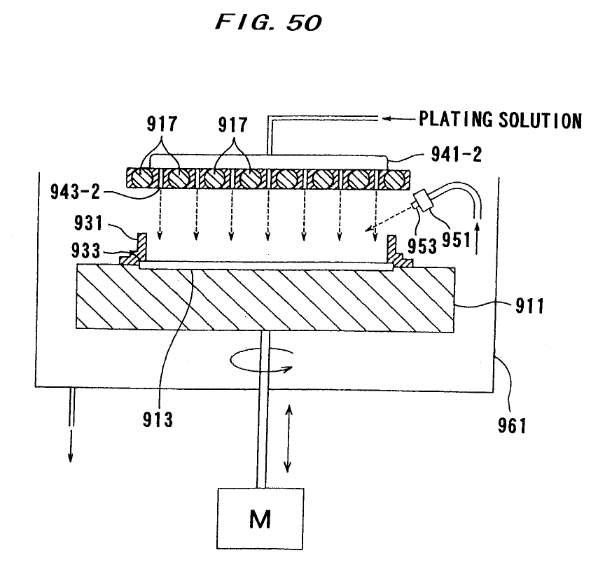

FIG. 50 is a schematic constitution drawing of another electroless plating apparatus. The electroless plating apparatus of FIG. 50 is different from the electroless plating apparatus of FIG. 49 in that instead of providing the backside heater 915 in the holding means 911, lamp heaters (heating means) 917 are disposed above the holding means 911, and the lamp heaters 917 and a shower head 941-2 are integrated. For example, a plurality of ring-shaped lamp heaters 917 having different radii are provided concentrically, and many nozzles 943-2 of the shower head 941-2 are open in a ring form from the gaps between the lamp heaters 917. The lamp heaters 917 may be composed of a single spiral lamp heater, or may be composed of other lamp heaters of various structures and arrangements.

Even with this constitution, the plating solution can be supplied from each nozzle 943-2 to the surface, to be plated, of the semiconductor substrate W substantially uniformly in a shower form. Further, heating and heat retention of the semiconductor substrate W can be performed by the lamp heaters 917 directly uniformly. The lamp heaters 917 heat not only the semiconductor substrate W and the plating solution, but also ambient air, thus exhibiting a heat retention effect on the semiconductor substrate W.

Direct heating of the semiconductor substrate W by the lamp heaters 917 requires the lamp heaters 917 with a relatively large electric power consumption. In place of such lamp heaters 917, lamp heaters 917 with a relatively small electric power consumption and the backside heater 915 shown in FIG. 49 may be used in combination to heat the semiconductor substrate W mainly with the backside heater 915 and to perform heat retention of the plating solution and ambient air mainly by the lamp heaters 917. In the same manner as in the aforementioned embodiment, means for directly or indirectly cooling the semiconductor substrate W may be provided to perform temperature control.

### EXAMPLE 1

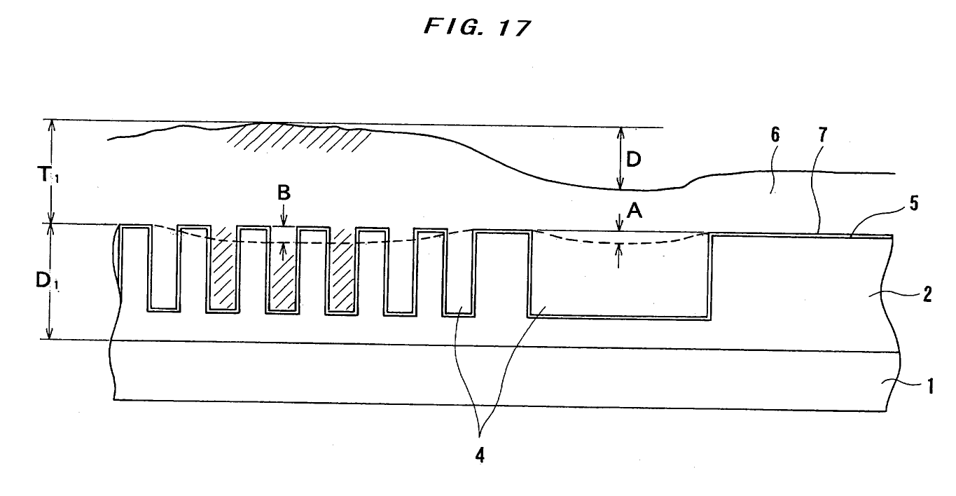

As shown in FIG. 17, an insulating layer of SiO₂ with a depth D₁ of about 1000 nm was formed by a CVD method using TEOS on a silicon substrate 1 in which an impurity-diffused region (not shown) has been formed, and then interconnect trenches 4 with a depth of about 700 nm were formed in the insulating layer 2 by the known photo-etching technique. Subsequently, a barrier layer 5 of TaN/Ta film with a thickness of 15 nm was deposited by a sputtering deposition method on the surface of insulating layer 2, inclusive of the interconnect trenches 4, and then a seed layer 7 was formed on the barrier layer. Thereafter, a copper film 6 with a thickness T₁ of about 900 nm was deposited by a copper electroplating method on the substrate inclusive of the interconnect trenches 4, thereby preparing a sample. The copper film 6 in the substrate surface was thickest, about 900 nm, in the local area dense with fine interconnect trenches 4 and thinnest, about 400 nm, above a trench with a wide opening, the thickness difference D being about 500 nm.

The sample was held with the copper-plated surface facing downward by the substrate holder 16a of the above-described polishing apparatus 10a shown in FIG. 4. While rotating the sample and the polishing tool 22 respectively at a rotational speed of 90 rpm in opposite directions, a polishing pressure of 300 g/cm² was applied to the to-be-polished surface and, at the same time, electropolishing utilizing the copper film 6 of the sample as an anode was carried out in the below-described polishing liquid, thereby carrying out a first polishing.

The polishing liquid used was prepared by dissolving 1.0% of ammonium oxalate and 0.5% of (85%) phosphoric acid in pure water, adding ammonia water to the solution to adjust the pH to 7.5, and further adding 3.5% of colloidal silica having an average particle size of 40 nm, 0.1% of 8-hydroxyquinoline and 0.03% of phenacetin to the solution. The polishing was carried out while supplying the polishing liquid so that the to-be-polished surface of the substrate was kept immersed in the polishing liquid. The temperature of the polishing liquid was adjusted so that to-be-polished surface was kept at 25° C.±1° C. during the polishing.

As an electric current to be supplied between the copper film 6 of the sample and the cathode plate 20, a pulse current of a repetition of 10×10⁻³ second current-on and 10×10⁻³ second current-off, and creating a current density, per surface area of copper on the substrate, of 2 A/dm², was employed.

After continuing the polishing for 60 seconds, the extra copper film 6 deposited on the substrate was polished from 900 nm to about 300 nm, and the maximum thickness difference decreased from 500 nm to 100 nm or less. The copper film was thus flattened.

Next, the sample was transferred to the polishing apparatus 10b shown in FIG. 6, and a second polishing was carried out. In the second polishing, the operating conditions of the polishing apparatus 10b and the polishing liquid were the same as in the above-described first polishing, but the manner of supplying electric current was changed. Thus, immediately after the start of operation of the polishing apparatus 10b and the commencement of polishing of the copper surface, a voltage of 50 V was applied between the cathode rods 40 and the anode rods 42.

After continuing the second polishing for 60 seconds, all of the extra copper film, inclusive of the barrier layer 5 of TaN film, was removed and a substrate with a flat surface of the insulating layer 2 of SiO₂ and of the copper film 6 in the interconnect trenches was obtained.

### EXAMPLE 2

A sample prepared in the same manner as in Example 1 was held with the copper-plated surface facing downward by the substrate holder 16a of the polishing apparatus 10a shown in FIG. 4. While rotating the sample and the polishing tool 22 respectively at a rotational speed of about 90 rpm in opposite directions, a polishing pressure of 250 g/cm² was applied to the to-be-polished surface and, at the same time, electropolishing utilizing the copper film 6 of the sample as an anode was carried out in the below-described polishing liquid, thereby carrying out a first polishing.

The polishing liquid used was prepared by dissolving 1.0% of ammonium oxalate and 2.0% of (85%) phosphoric acid in pure water, adding ammonia water to the solution to adjust the pH to 8.5, and further adding 3.5% of colloidal silica having an average particle size of 40 nm, 0.15% of 8-hydroxyquinoline and 30 mg/L of nonionic surfactant to the solution. The polishing liquid was continuously supplied so that the to-be-polished surface of the sample was kept immersed in the polishing liquid.

As an electric current to be supplied between the copper film 6 of the sample and the cathode plate 20, a pulse current of a repetition of 10×10⁻³ second current-on and 10×10⁻³ second current-off, and creating a current density, per surface area of copper on the sample, of 3 A/dm², was employed. The pulse current was flowed for 45 seconds.

After carrying out the composite electropolishing under the above conditions, the extra copper film 6 deposited on the substrate was polished from 900 nm to 300 nm, and the maximum thickness difference decreased from 500 nm to 100 nm or less. The copper film was thus flattened.

Next, a second polishing of the sample was carried out by a known method, using a polishing liquid containing 8-hydroxyquinoline and not employing electrolysis. Thus, polishing was carried out by allowing the substrate held with the to-be-polished surface facing downward to be in pressure contact with a pad of a hard/soft double structure (e.g. IC1000/SUBA400 manufactured by Rodel Nitta Company), mounted on a turntable facing the substrate, under a polishing pressure of 350 g/cm² while rotating the substrate and the pad respectively at 70 rpm in opposite directions and continuously supplying the below-described polishing liquid.

The polishing liquid used had the composition of; 1.0% of ammonium oxalate, 10% of hydrogen peroxide, 5.0% of colloidal silica having an average particle size of 40 nm, 30 mg/L of nonionic surfactant, 0.05% of 5-methyl benzotriazole, and 0.1% of 8-hydroxyquinoline. The surface of copper film 6 was covered with a fragile film of oxine-copper formed by the reaction between the copper and 8-hydroxyquinoline, and the raised portions were selectively removed. Accordingly, polishing and flattening of the copper film further advanced.

When the extra copper film 6 deposited on the substrate was polished away and the barrier layer 5 of TaN/Ta film became exposed, the copper surface was protected with a protective film-forming inhibitor (5-methyl benzotriazole), and the etch-back of the barrier layer 5 was effected smoothly by the actions of the organic acid and hydrogen peroxide. As a result, upon completion of the polishing, the surface of insulating layer 2 of SiO₂ became almost flush with the surface of copper film 6 in the interconnect trenches. Further, as shown by the imaginary line in FIG. 17, the depth A of dishing and the depth B of erosion were both as small as 20-50 nm.

### EXAMPLE 3

A sample was prepared in the same manner as in Example 1, except that the thickness T₁ of the copper film 6 deposited on the silicon substrate was changed to about 1200 nm. The sample was polished in two steps. The maximum thickness difference D in the copper film 6 was 600 nm.

First, as in Example 2, the sample was held with the copper-plated surface facing downward by the substrate holder 16a of the polishing apparatus 10a shown in FIG. 4. While rotating the sample and the polishing tool 22 respectively at a rotational speed of about 90 rpm in opposite directions, a polishing pressure of 250 g/cm² was applied to the to-be-polished surface and, at the same time, electropolishing utilizing the copper film 6 of the sample as an anode was carried out in the below-described polishing liquid, thereby carrying out a first polishing.

The polishing liquid used was prepared by dissolving 5.0% of (85%) phosphoric acid in pure water, adding ammonia water to the solution to adjust the pH to 6.5, and further adding 2.0% of y-alumina having an average particle size of 30 nm, 2.0% of colloidal silica having an average particle size of 40 nm, 0.15% of 8-hydroxyquinoline, 50 mg/L of nonionic surfactant and 0.1% of propylene urea to the solution.

As an electric current to be supplied between the copper film 6 of the sample and the cathode plate 20, a pulse current of a repetition of 10×10⁻³ second current-on and 10×10⁻³ second current-off, and creating a current density, per surface area of copper on the substrate, of 4 A/dm², was employed. The pulse current was flowed for 55 seconds.

As a result, the extra copper film 6 deposited on the substrate was polished from 1200 nm to 300 nm, and the polishing rate of the raised portions reached 1100 nm/min. The maximum thickness difference decreased from 600 nm to 100 nm or less, indicating a remarkable flattening effect.

Next, the sample was transferred to a separate CMP apparatus, and further polishing and flattening of the sample was carried out by using a polishing liquid containing 8-hydroxyquinoline, without employing electropolishing. Thus, polishing was carried out by allowing the substrate held with the to-be-polished surface facing downward to be in pressure contact with a pad of a hard/soft double structure, mounted on a turntable facing the substrate, under a polishing pressure of 350 g/cm² while rotating the substrate and the pad respectively at 70 rpm in opposite directions. During the polishing, the below-described polishing liquid was continuously supplied to the to-be-polished surface.

The polishing liquid used had the composition of: 1.0% of ammonium oxalate, 0.5% of ammonium phosphate, 2.0% of γ-alumina, 3.0% of colloidal silica having an average particle size of 40 nm, 0.1% of 8-hydroxyquinoline, 30 mg/L of nonionic surfactant, and 0.05% of 5-methyl benzotriazole. A fragile film of oxine-copper was formed in the surface of copper, and the raised portions were selectively removed. Accordingly, polishing and flattening of the copper film further advanced.

When the extra copper film 6 deposited on the substrate was polished away and the barrier layer 5 of TaN/Ta film became exposed, the copper surface was protected with oxine-copper and the inhibitor, and the etch-back of the barrier layer 5 was effected smoothly. Upon completion of the polishing, the surface of insulating layer 2 of SiO₂ became almost flush with the surface of copper in the interconnect trenches, and a product with suppressed dishing and erosion was obtained.

### EXAMPLE 4

A sample was prepared in the same manner as in Example 1, except that the thickness T₁ of the copper film 6 deposited on the silicon substrate was changed to about 1200 nm. The sample was polished in two steps. The maximum thickness difference D in the copper film 6 was 600 nm. Composite electropolishing of the sample was carried out in early and later two steps. In the early step, composite electropolishing was carried out by utilizing the copper surface as an anode and employing electropolishing in combination with mechanical polishing. In the later step, composite electropolishing was carried out by applying a high voltage between cathodes and anodes disposed opposite to the substrate, and making the substrate surface close to the cathodes locally pseudo-anodes by utilizing the bipolar phenomenon to thereby increase the solubility of copper.

In the early polishing step, the sample was held with the copper-plated surface facing downward by the substrate holder 16a of the polishing apparatus 10a shown in FIG. 4. While rotating the sample and the polishing tool 22 respectively at a rotational speed of about 90 rpm in opposite directions, a polishing pressure of 250 g/cm² was applied to the to-be-polished surface and, at the same time, electropolishing utilizing the copper film 6 of the sample as an anode was carried out in the below-described polishing liquid, thereby carrying out the early polishing step.

The polishing liquid used was prepared by dissolving 5.0% of (85%) phosphoric acid in pure water, adding ammonia water to the solution to adjust the pH to 5.5, and further adding 10% of propylene glycol monomethyl ether, 5.0% of colloidal silica having an average particle size of 40 nm, 0.15% of 8-hydroxyquinoline and 0.1% of propylene urea to the solution.

As an electric current to be supplied between the copper film 6 of the sample and the cathode plate 20, a pulse current of a repetition of 10×10⁻³ second current-on and 10×10⁻³ second current-off, and creating a current density, per surface area of copper on the substrate, of 3 A/dm², was employed.

After continuing the polishing for 60 seconds, the extra copper film 6 deposited on the substrate was polished from 1200 nm to about 300 nm, and the maximum thickness difference decreased from 600 nm to 100 nm or less, indicating a high flattening effect.

Next, using the polishing apparatus 10b shown in FIG. 6, the later step of polishing of the sample was carried out in the same manner as in Example 1. Thus, the polishing liquid used was prepared by dissolving 1.0% of ammonium oxalate and 0.5% of (85%) phosphoric acid in pure water, adding ammonia water to the solution to adjust the pH to 7.5, and further adding 3.5% of colloidal silica having an average particle size of 40 nm, 0.1% of 8-hydroxyquinoline and 0.03% of phenacetin to the solution.

Immediately after the start of operation of the polishing apparatus 10b and the commencement of polishing of the copper surface, a voltage of 30-70 V was applied between the cathode rods 40 and the anode rods 42, thereby flowing electric current therebetween. During the polishing, formation and removal of oxine-copper were effected selectively with respect to the raised portions of the copper surface, and flattening of the copper surface advanced with the progress of polishing.

After applying the voltage for 40 seconds, the supply of current was cut off, and polishing was further continued. Upon completion of the polishing when the barrier layer 5 of TaN/Ta film had been removed, the surface of the insulating layer 2 of SiO₂ and of the copper in the interconnect trenches was almost flat, providing a good polished surface.

### EXAMPLE 5

A sample was prepared in the same manner as in Example 1, except that the thickness T₁ of the copper film 6 deposited on the silicon substrate was changed to about 1500 nm. The sample was polished in two steps. The maximum thickness difference D in the copper film 6 was 700 nm.

In the early polishing step, the sample was held with the copper-plated surface facing downward by the substrate holder 16a of the polishing apparatus 10a shown in FIG. 4. While rotating the sample and the polishing tool 22 respectively at a rotational speed of 90 rpm in opposite directions, a polishing pressure of 200 g/cm² was applied to the to-be-polished surface and, at the same time, electropolishing utilizing the to-be-polished surface as an anode was carried out by continuously supplying the below-described polishing liquid so as to keep the to-be-polished surface immersed in the liquid and flowing the below-described pulse direct current, thereby carrying out composite electropolishing.

The polishing liquid used was prepared by dissolving 10% of (85%) phosphoric acid and 20% of propylene glycol monomethyl ether in pure water, adding ammonia water to the solution to adjust the pH to 3.5, and further dissolving 0.15% of 8-hydroxyquinoline and 0.2% of propylene urea in the solution.

As an electric current to be supplied between the copper film 6 of the sample and the cathode plate 20, a pulse current of a repetition of 10×10⁻³ second current-on and 10×10⁻³ second current-off, and creating a current density, per surface area of copper on the substrate, of 6 A/dm², was employed.

After carrying out the composite electropolishing for 65 seconds, the copper film 6 was polished from 1500 nm to 300 nm, and the polishing rate at the raised portions reached 1200 nm/min. The maximum thickness difference decreased from 700 nm to 100 nm or less, indicating a high flattening effect.

The polishing liquid that flowed out of the polishing apparatus 10a was recovered, and filtered through a polypropylene cartridge filter having 100-micron, 5-micron and 1-micron filters disposed in series and, after carrying out concentration adjustment of the components, was supplied again to the polishing apparatus 10a and used in polishing. As a result, there was observed no adverse influence on the processing and on the results of polishing of the substrate.

Next, the later step of polishing was carried out in the same manner as in Example 2, i.e., not employing electrolysis, using the below-described polishing liquid containing 8-hydroxyquinoline, and according to the known CMP method. Thus, polishing and flattening was carried out by allowing the substrate held with the to-be-polished surface facing downward to be in pressure contact with a pad of a hard/soft double structure, mounted on a turntable facing the substrate, under a polishing pressure of 350 g/cm² while rotating the substrate and the pad respectively at 70 rpm in opposite directions.

The polishing liquid used had the composition of: 1.0% of ammonium oxalate, 10% of hydrogen peroxide, 5.0% of colloidal silica having an average particle size of 40 nm, 30 mg/L of nonionic surfactant, 0.05% of 5-methyl benzotriazole, and 0.1% of 8-hydroxyquinoline. The polishing liquid was continuously supplied from the polishing liquid supply unit 32 to the to-be-polished surface.

In the later step of polishing, a fragile film of oxine-copper was formed in the surface of copper film, and removal/formation of the oxine-copper film was repeated selectively with respect to the raised portions, whereby flattening of the copper film further advanced with the progress of polishing.

When the extra copper film 6 deposited on the substrate was removed with the progress of polishing and the barrier layer 5 of TaN/Ta film became exposed, the copper surface was protected with an anticorrosion film of oxine-copper and of the inhibitor, and the etch-back of the barrier layer 5 was effected smoothly by the actions of the organic acid and hydrogen peroxide. As a result, upon completion of the polishing, the surface of insulating layer 2 of SiO₂ became almost flush with the surface of copper in the interconnect trenches, and a product with minimized dishing and erosion was obtained.

As described hereinabove, according to the present invention, in carrying out polishing and flattening of a copper film with irregularities deposited in excess on a substrate, an insoluble fragile oxine-copper is formed in the surface of the copper film and the raised portions are selectively polished away, whereby the flattening processing can be effected with high efficiency. Further, the present composite electropolishing, which employs electrolysis, can polish most of the extra copper film at a high rate and, owing to the electrolytic action, can eliminate the use of an oxidizing agent in the polishing liquid, thereby facilitating stabilization and management of the polishing liquid and lowering the running cost. Furthermore, in an early stage of polishing, the use of abrasive grains in the polishing liquid can be eliminated, making it possible to reuse the polishing liquid after its recovery, filtration and concentration adjustment. The reuse of polishing liquid, which reduces waste liquid, is desirable in the light of environmental conservation.

The present invention is advantageously applicable to a polishing liquid for use in removing (polishing) an extra copper, etc. deposited on a substrate, upon forming embedded interconnects by embedding a conductor, such as copper, in interconnect trenches provided in an interlevel dielectric in the formation of a semiconductor device of a multi-layer structure, and to a polishing method and an polishing apparatus using the polishing liquid.

What is claimed is:

1. A polishing liquid for polishing the surface of a substrate having a copper film and fine recesses filled with the copper, comprising:
at least one water-soluble inorganic acid or its salt, or water-soluble organic acid or its salt; and
at least one hydroxyquinoline.

2. The polishing liquid according to claim 1, wherein the inorganic acid salt is a potassium or ammonium salt of an inorganic acid, and the organic acid salt is a potassium, ammonium, amine or hydroxyamine salt of an organic acid.

3. The polishing liquid according to claim 1, wherein the hydroxyquinoline is 2-hydroxyquinoline, 4-hydroxyquinoline, 5-hydroxyquinoline or 8-hydroxyquinoline.

4. The polishing liquid according to claim 1, wherein the concentration of the water-soluble inorganic acid or its salt, or the water-soluble organic acid or its salt in the polishing liquid is 0.01 to 5.0 mol/L, and the electric conductivity of the polishing liquid is 0.5 to 100 mS/cm.

5. The polishing liquid according to clam 1, wherein the concentration of the hydroxyquinoline in the polishing liquid is 0.001 to 1.0% by weight.

6. The polishing liquid according to claim 1, further comprising at least one of benzotriazole or its derivative, benzoimidazole and phenacetin as an anticorrosion and antidiscoloration agent for copper in a concentration of 0.001 to 0.5% by weight.

7. The polishing liquid according to claim 1, wherein the liquid pH is in the range of 3-11.

8. The polishing liquid according to claim 1, further comprising a surfactant in a concentration of 0.001 to 0.1% by weight.

9. An electrochemical/chemical/mechanical composite polishing method for polishing the surface of a substrate having a copper film and fine recesses filled with the copper, comprising:
electropolishing the surface of the substrate in a polishing liquid containing at least one water-soluble inorganic acid or its salt, or water-soluble organic acid or its salt, and at least one hydroxyquinoline; and
simultaneously polishing away an oxine-copper film formed in the copper surface by the reaction between copper and the hydroxyquinoline added in the polishing liquid.

10. The polishing method according to claim 9, wherein the electropolishing is carried out by supplying either a direct current or a pulse current, or a superimposed current thereof.

11. The polishing method according to claim 9, wherein the electropolishing is carried out by initially flowing such an electric current that creates a current density, per surface area of copper, of 0.5 to 5.0 A/dm².

12. The polishing method according to claim 9, wherein a number of anodes and cathodes, facing the copper film of the substrate, are disposed alternately in the polishing liquid such that the cathodes are closer to the substrate than the anodes, and a voltage is applied between the anodes and the cathodes to make the copper surface positive polar due to a bipolar phenomenon, thereby forming the oxine-copper film in the copper surface.

13. The polishing method according to claim 12, wherein the resistance between the cathodes and the anodes in the polishing liquid is 10 to 50 Ωcm, and the voltage applied between the cathodes and the anodes is 10 to 100 V.

14. The polishing method according to claim 9, wherein the inorganic acid salt is a potassium or ammonium salt of an inorganic acid, and the organic acid salt is a potassium, ammonium, amine or hydroxyamine salt of an organic acid.

15. The polishing method according to claim 9, wherein the hydroxyquinoline is 2-hydroxyquinoline, 4-hydroxyquinoline, 5-hydroxyquinoline or 8-hydroxyquinoline.

16. The polishing method according to claim 9, wherein the concentration of the water-soluble inorganic acid or its salt, or the water-soluble organic acid or its salt in the polishing liquid is 0.01 to 5.0 mol/L, and the electric conductivity of the polishing liquid is 0.5 to 100 mS/cm.

17. The polishing method according to claim 9, wherein the concentration of the hydroxyquinoline in the polishing liquid is 0.001 to 1.0% by weight.

18. The polishing method according to claim 9, further comprising at least one of benzotriazole or its derivative, benzoimidazole and phenacetin as an antidiscoloration and anticorrosion agent for copper in a concentration of 0.001 to 0.5% by weight.

19. The polishing method according to claim 9, wherein the liquid pH is in the range of 3-11.

20. The polishing method according to claim 9, further comprising a surfactant in a concentration of 0.001 to 0.1% by weight.

21. A polishing apparatus for polishing the surface of a substrate having a copper film and fine recesses filled with the copper, characterized by electropolishing the surface of the substrate in a polishing liquid containing at least one water-soluble inorganic acid or its salt, or water-soluble organic acid or its salt, and at least one hydroxyquinoline, and simultaneously polishing away an oxine-copper film formed in the copper surface by the reaction between copper and the hydroxyquinoline.

22. The polishing apparatus according to claim 21, wherein the inorganic acid salt is a potassium or ammonium salt of an inorganic acid, and the organic acid salt is a potassium, ammonium, amine or hydroxyamine salt of an organic acid.

23. The polishing apparatus according to claim 21, wherein the hydroxyquinoline is 2-hydroxyquinoline, 4-hydroxyquinoline, 5-hydroxyquinoline or 8-hydroxyquinoline.

24. The polishing apparatus according to claim 21, wherein the concentration of the water-soluble inorganic acid or its salt, or the water-soluble organic acid or its salt in the polishing liquid is 0.01 to 5.0 mol/L, and the electric conductivity of the polishing liquid is 0.5 to 100 mS/cm.

25. The polishing apparatus according to clam 21, wherein the concentration of the hydroxyquinoline in the polishing liquid is 0.001 to 1.0% by weight.

26. The polishing apparatus according to claim 21, further comprising at least one of benzotriazole or its derivative, benzoimidazole and phenacetin as an anticorrosion and antidiscoloration agent for copper in a concentration of 0.001 to 0.5% by weight.

27. The polishing apparatus according to claim 21, wherein the liquid pH is in the range of 3-11.

28. The polishing apparatus according to claim 21, further comprising a surfactant in a concentration of 0.001 to 0.1% by weight.

29. A polishing apparatus, comprising:
a substrate holder for holding a substrate with its surface facing downward;
a polishing bath holding a polishing liquid containing at least one water-soluble inorganic acid or its salt, or water-soluble organic acid or its salt, and at least one hydroxyquinoline;
a cathode plate immersed in the polishing liquid held in the polishing bath;
a polishing tool disposed opposite to the cathode plate and immersed in the polishing liquid held in the polishing bath; and
a relative movement mechanism for allowing the substrate held by the substrate holder and the polishing tool to make a relative movement.

30. The polishing apparatus according to claim 29, wherein a number of grooves, extending continuously over the full length of the cathode plate, are formed in the surface of the cathode plate.

31. The polishing apparatus according to claim 29, wherein the inorganic acid salt is a potassium or ammonium salt of an inorganic acid, and the organic acid salt is a potassium, ammonium, amine or hydroxyamine salt of an organic acid.

32. The polishing apparatus according to claim 29, wherein the hydroxyquinoline is 2-hydroxyquinoline, 4-hydroxyquinoline, 5-hydroxyquinoline or 8-hydroxyquinoline.

33. The polishing apparatus according to claim 29, wherein the concentration of the water-soluble inorganic acid or its salt, or the water-soluble organic acid or its salt in the polishing liquid is 0.01 to 5.0 mol/L, and the electric conductivity of the polishing liquid is 0.5 to 100 mS/cm.

34. The polishing apparatus according to clam 29, wherein the concentration of the hydroxyquinoline in the polishing liquid is 0.001 to 1.0% by weight.

35. The polishing apparatus according to claim 29, further comprising at least one of benzotriazole or its derivative, benzoimidazole and phenacetin as an antidiscoloration and anticorrosion agent for copper in a concentration of 0.001 to 0.5% by weight.

36. The polishing apparatus according to claim 29, wherein the liquid pH is in the range of 3-11.

37. The polishing apparatus according to claim 29, further comprising a surfactant in a concentration of 0.001 to 0.1% by weight.

38. A polishing apparatus, comprising;
a substrate holder for holding a substrate;
a polishing bath holding a polishing liquid containing at least one water-soluble inorganic acid or its salt, or water-soluble organic acid or its salt, and at least one hydroxyquinoline;
an electrode plate having a number of anodes and cathodes electrically isolated from one another and disposed alternately such that the cathodes are closer to the substrate held by the substrate holder than the anodes;
a power source for applying a voltage between the anodes and the cathodes;
a polishing tool disposed opposite to the electrode plate and immersed in the polishing liquid held in the polishing bath; and
a relative movement mechanism for allowing the substrate held by the substrate holder and the polishing tool to make a relative movement.

39. The polishing apparatus according to claim 38, wherein a number of grooves, extending continuously over the full length of the cathode plate, are formed in the surface of the cathode plate.

40. The polishing apparatus according to claim 38, wherein the inorganic acid salt is a potassium or ammonium salt of an inorganic acid, and the organic acid salt is a potassium, ammonium, amine or hydroxyamine salt of an organic acid.

41. The polishing apparatus according to claim 38, wherein the hydroxyquinoline is 2-hydroxyquinoline, 4-hydroxyquinoline, 5-hydroxyquinoline or 8-hydroxyquinoline.

42. The polishing apparatus according to claim 38, wherein the concentration of the water-soluble inorganic acid or its salt, or the water-soluble organic acid or its salt in the polishing liquid is 0.01 to 5.0 mol/L, and the electric conductivity of the polishing liquid is 0.5 to 100 mS/cm.

43. The polishing apparatus according to clam 38, wherein the concentration of the hydroxyquinoline in the polishing liquid is, 0.001 to 1.0% by weight.

44. The polishing apparatus according to claim 38, further comprising at least one of benzotriazole or its derivative, benzoimidazole and phenacetin as an antidiscoloration and anticorrosion agent for copper in a concentration of 0.001 to 0.5% by weight.

45. The polishing apparatus according to claim 38, wherein the liquid pH is in the range of 3-11.

46. The polishing apparatus according to claim 38, further comprising a surfactant in a concentration of 0.001 to 0.1% by weight.

47. A polishing apparatus, comprising:
a first polishing apparatus; including,
(i) a substrate holder for holding a substrate with its surface downward,
(ii) a polishing bath holding a polishing liquid containing at least one water-soluble inorganic acid or its salt, or water-soluble organic acid or its salt, and at least one hydroxyquinoline,
(iii) a cathode plate immersed in the polishing liquid held in the polishing bath,
(iv) a polishing tool disposed opposite to the cathode plate and immersed in the polishing liquid held in the polishing bath, and
(v) a relative movement mechanism for allowing the substrate held by the substrate holder and the polishing tool to make a relative movement; and
a second polishing apparatus; including
(i) a substrate holder for holding a substrate,
(ii) a polishing bath holding a polishing liquid containing at least one water-soluble inorganic acid or its salt, or water-soluble organic acid or its salt, and at least one hydroxyquinoline,
(iii) an electrode plate having a number of anodes and cathodes electrically isolated from one another and disposed alternately such that the cathodes are closer to the substrate held by the substrate holder than the anodes,
(iv) a power source for applying a voltage between the anodes and the cathodes,
(v) a polishing tool disposed opposite to the electrode plate and immersed in the polishing liquid held in the polishing bath, and
(vi) a relative movement mechanism for allowing the substrate held by the substrate holder and the polishing tool to make a relative movement;
wherein the first polishing apparatus and the second polishing apparatus are disposed in the same partitioned room or module, and the substrate is moved between the polishing apparatuses by a pivotable arm.

48. The polishing apparatus according to claim 47, wherein the inorganic acid salt is a potassium or ammonium salt of an inorganic acid, and the organic acid salt is a potassium, ammonium, amine or hydroxyamine salt of an organic acid.

49. The polishing apparatus according to claim 47, wherein the hydroxyquinoline is 2-hydroxyquinoline, 4-hydroxyquinoline, 5-hydroxyquinoline or 8-hydroxyquinoline.

50. The polishing apparatus according to claim 47, wherein the concentration of the water-soluble inorganic acid or its salt, or the water-soluble organic acid or its salt in the polishing liquid is 0.01 to 5.0 mol/L, and the electric conductivity of the polishing liquid is 0.5 to 100 mS/cm.

51. The polishing apparatus according to clam 47, wherein the concentration of the hydroxyquinoline in the polishing liquid is 0.001 to 1.0% by weight.

52. The polishing apparatus according to claim 47, further comprising at least one of benzotriazole or its derivative, benzoimidazole and phenacetin as an anticorrosion and antidiscoloration agent for copper in a concentration of 0.001 to 0.5% by weight.

53. The polishing apparatus according to claim 47, wherein the liquid pH is in the range of 3-11.

54. The polishing apparatus according to claim 47, further comprising a surfactant in a concentration of 0.001 to 0.1% by weight.
